(19) United States
(12) Patent Application Publication
(10) Pub. No.: US 2014/0336028 A1
(43) Pub. Date: Nov. 13, 2014

(54) Packaging Device

(71) Applicants: Toshihiro Takahashi, Nagoya-shi (JP); Teruo Imamaki, Nissin-shi (JP)

(72) Inventors: Toshihiro Takahashi, Nagoya-shi (JP); Teruo Imamaki, Nissin-shi (JP)

(73) Assignee: Brother Kogyo Kabushiki Kaisha, Nagoya-shi (JP)

(21) Appl. No.: 14/080,902

(22) Filed: Nov. 15, 2013

(30) Foreign Application Priority Data
May 10, 2013 (JP) 2013-100581

(51) Int. Cl. B31B 1/64

(52) U.S. Cl. CPC B31B 1/64
USPC 493/199

(57) ABSTRACT

A packaging device includes a conveyance mechanism, a heater, a guide portion, and a processor. The conveyance mechanism is configured to convey a base along a conveyance path. The heater is configured to heat the film and bond the film to the base that is conveyed by the conveyor. The guide portion is configured to guide the film toward the heater and move along a movement path that extends in a direction intersecting the conveyance path. The processor is configured to control the conveyance mechanism, the heater, and the guide portion.

### CROSS-REFERENCE TO RELATED APPLICATION

This application claims priority to Japanese Patent Application No. 2013-100581, filed May 10, 2013. The disclosure of the foregoing application is incorporated herein by reference in its entirety.

### BACKGROUND

The present disclosure relates to a packaging device that is configured to package an object that is placed on a piece of cardboard by covering both the object and the piece of cardboard with a film.

A packaging device is known that packages an object that is placed on a piece of cardboard, such as corrugated cardboard or the like, by covering both the object and the cardboard with a film. The packaging device places the film over the upper side of the object, and causes the end of the film to reach around to a surface (hereinafter called a “lower surface”) of the piece of cardboard opposite to the side on which the object is placed. The end of the film is fixed to the lower surface of the piece of cardboard. A tension is applied to the film and the object is fixed onto the piece of cardboard by the film. The film is in close contact with the object and an operator cannot directly touch the object from the outside. The object is protected by the film.

A technology is known in which a receiving member that guides the film goes around the periphery of the object and thereby causes the film to be firmly attached to the periphery of the object. By applying this technology to the above-described packaging device, the packaging device can cause the film to be firmly attached to the periphery of the object placed on the piece of cardboard.

### SUMMARY

In this case, unless the path of the receiving member that goes around is larger than the object, it is not possible to package the object with the film. In order to package a large object, there is a possibility that the size of the packaging device is increased.

Various embodiments of the broad principles derived herein provide a packaging device that is configured to package a relatively large object with a film without increasing a device size.

Various embodiments of the broad principles derived herein provide a packaging device that is configured to package, with a film, an object and a base on which the object is placed. The packaging device includes a conveyance mechanism, a heater, a guide portion, and a processor. The conveyance mechanism is configured to convey the base along a specific conveyance path. The heater is configured to heat the film and bond the film to the base that is conveyed by the conveyance mechanism. The heater is configured to move between a proximate position, a separate position and a stand-by position. The proximate position is a position at which the heater is in close proximity to the conveyance path. The separate position is a position at which the heater is separated from the conveyance path. The stand-by position is a position that is positioned between the separate position and the proximate position. The guide portion is configured to guide the film toward the heater and is configured to move along a movement path. The movement path extends in a direction intersecting the conveyance path. The processor is configured to cause the conveyance mechanism to convey the base from a start position to a first bonding position in a state in which the guide portion is in a first guiding position and in which the film that is guided from the guide portion to the heater intersects the conveyance path. The first guiding position is a position on the movement path at which the guide portion and the heater are disposed on different sides of the conveyance path. The start position is a position on the conveyance path at which the base is disposed before being packaged by the film. The first bonding position is another position on the conveyance path at which the heater can bond the film to a first base end. The first base end is an end of the base in a first direction. The first direction is a direction from the start position toward an end position. The end position is yet another position on the conveyance path at which the base is disposed after being packaged by the film. The first bonding position is positioned between the start position and the end position. The processor is further configured to move the heater from the separate position to the stand-by position when the base is conveyed from the start position to the first bonding position. The processor is further configured to move the heater from the stand-by position to the proximate position when the base is conveyed to the first bonding position, and cause the heater to bond the film to the first base end. The processor is further configured to cause the conveyance mechanism to convey the base from the first bonding position to an avoidance position after the film is bonded to the first base end. The avoidance position is yet another position on the conveyance path at which the whole of the base is positioned further in the first direction than the movement path. The avoidance position is positioned between the start position and the end position and is positioned further in the first direction than the first bonding position. The processor is further configured to cover, with the film, the object that is placed on the base, by moving the guide portion from the first guiding position to a second guiding position after the base is conveyed to the avoidance position. The second guiding position is yet another position on the movement path at which the guide portion and the heater are disposed on the same side of the conveyance path. The processor is further configured to cause the conveyance mechanism to convey the base from the avoidance position to a second bonding position in a state in which the film extending from the guide portion toward the object intersects the conveyance path after the guide portion is moved to the second guiding position. The second bonding position is yet another position on the conveyance path at which the heater can bond the film to a second base end. The second base end is an end of the base in a second direction. The second direction is a direction from the start position toward the end position. The second bonding position is positioned between the first bonding position and the avoidance position. The processor is further configured to move the heater from the separate position to the proximate position after the base is conveyed to the second bonding position, and cause the heater to bond the film to the second base end. The processor is further configured to cause the conveyance mechanism to convey the base from the second bonding position to the end position after the film is bonded to the second base end.

### BRIEF DESCRIPTION OF THE DRAWINGS

Embodiments of the present disclosure will be described below in detail with reference to the accompanying drawings in which:

FIG. 1 is an oblique view of a packaging device on which a housing is mounted;

FIG. 2 is a right side view of the packaging device on which the housing is mounted;

FIG. 3 is another oblique view of the packaging device on which the housing is mounted;

FIG. 4 is an oblique view of the packaging device, as seen from the upstream side, with the housing removed;

FIG. 5 is an oblique view of the packaging device, as seen from the downstream side, with the housing removed;

FIG. 6 is an oblique view of a conveyance mechanism;

FIG. 7 is an enlarged oblique view of a first conveyance portion and a second conveyance portion;

FIG. 8 is a right side view of the downstream side of a receiving tray;

FIG. 9 is an oblique view of a vicinity of an upper end of a side plate portion;

FIG. 10 is an oblique view of a film cassette and a torque adjustment mechanism;

FIG. 11 is an oblique view of a film roll and the torque adjustment mechanism;

FIG. 12 is an oblique view of movable rollers;

FIG. 13 is a right side view of a state in which a support portion is raised;

FIG. 14 is a right side view of a state in which the support portion is lowered;

FIG. 15 is an oblique view of a base guide roller, a holding roller and a heating portion;

FIG. 16 is an oblique view of the movable rollers, the heating portion and a rotation control portion;

FIG. 17 is another oblique view of the movable rollers, the heating portion and the rotation control portion;

FIG. 18 is an oblique view of a base;

FIG. 19 is a plan view of the base that is placed on a receiving tray;

FIG. 20 is a block diagram showing an electrical configuration of the packaging device;

FIG. 21 is a diagram showing a first operation control table;

FIG. 22 is a diagram showing a second operation control table;

FIG. 23 is a diagram showing a tension adjustment table;

FIG. 24 is a flowchart of initialization processing;

FIG. 25 is a timing chart of the initialization processing;

FIG. 26 is a flowchart of packaging processing;

FIG. 27 is a flowchart of the packaging processing and is a continuation of FIG. 26;

FIG. 28 is a timing chart of the packaging processing;

FIG. 29 is a timing chart of the packaging processing and is a continuation of FIG. 28;

FIG. 30 is a flowchart of forced discharge processing;

FIG. 31 is a timing chart of the forced discharge processing;

FIG. 32 is a state-transition diagram of the packaging device during the packaging processing;

FIG. 33 is a state-transition diagram of the packaging device during the packaging processing and is a continuation of FIG. 32;

FIG. 34 is a state-transition diagram of the packaging device during the packaging processing and is a continuation of FIG. 33;

FIG. 35 is a state-transition diagram of the packaging device during the packaging processing and is a continuation of FIG. 34;

FIG. 36 is a state-transition diagram of the packaging device during the packaging processing and is a continuation of FIG. 35;

FIG. 37 is a state-transition diagram of the packaging device during the packaging processing and is a continuation of FIG. 36;

FIG. 38 is a state-transition diagram of the packaging device during the packaging processing and is a continuation of FIG. 37;

FIG. 39 is a state-transition diagram of the packaging device during the packaging processing and is a continuation of FIG. 38;

FIG. 40 is a state-transition diagram of the packaging device during the packaging processing and is a continuation of FIG. 39; and

FIG. 41 is a state-transition diagram of the packaging device during the packaging processing and is a continuation of FIG. 40.

### DETAILED DESCRIPTION

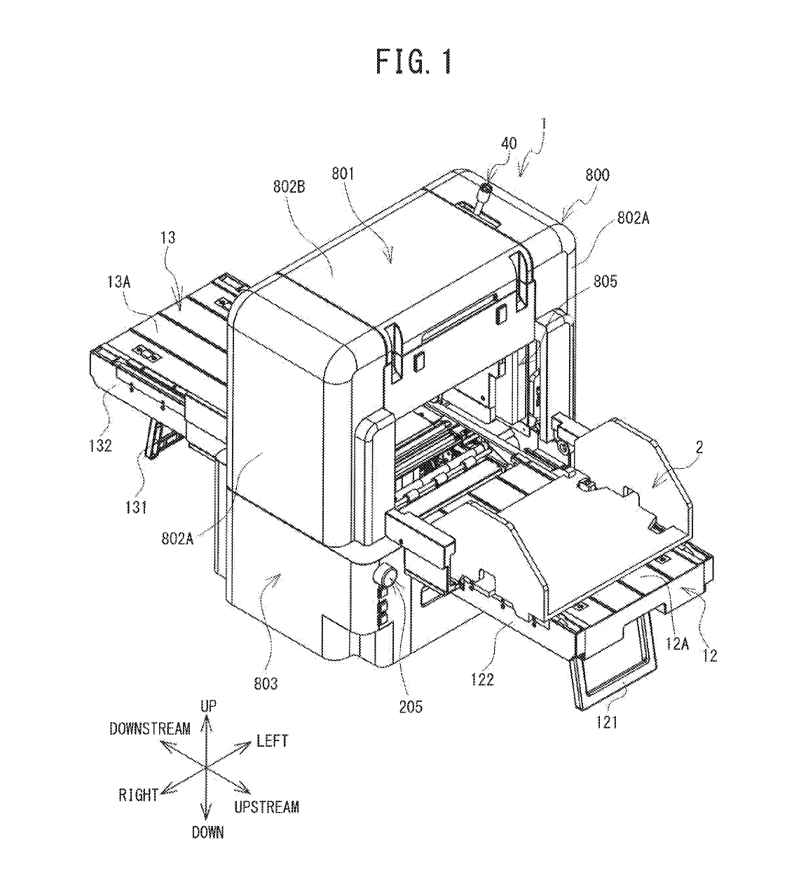

An embodiment of the present disclosure will be explained with reference to the drawings. A packaging device 1 covers the upper side of an object 3 that is placed on a base 2, such as a piece of cardboard, with a film 24 and fixes the object 3 onto the base 2, thus packaging the object 3. Hereinafter, packaging the object 3 in this manner is called “packaging the base 2 and the object 3”. The packaging device 1 conveys the base 2 on which the object 3 is placed from the lower right side to the upper left side of FIG. 1, and packages the base 2 and the object 3. The upper side, the lower side, the lower left side and the upper right side of FIG. 1 are respectively called the upper side, the lower side, the right side and the left side of the packaging device 1. The lower right side and the upper left side of FIG. 1 are respectively called the upstream side and the downstream side in the conveyance direction.

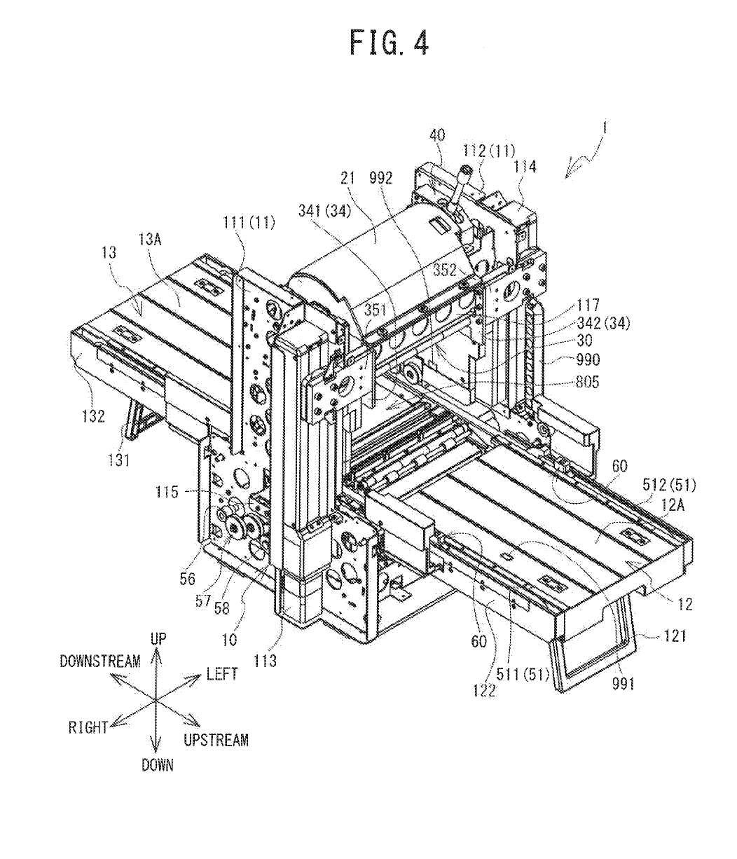

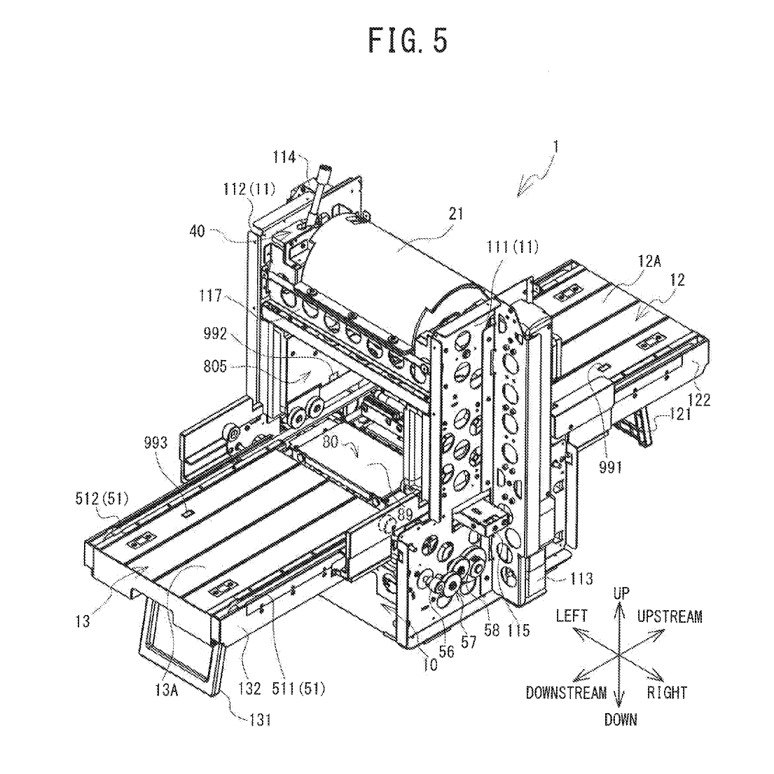

As shown in FIG. 1 to FIG. 3, the packaging device 1 is provided with a housing 800. The shape of the housing 800 is a substantially cuboid shape whose long sides extend in the up-down direction. The housing 800 is provided with an upper housing 801 and a lower housing 803. The shape of the lower housing 803 is a substantially cuboid shape whose long sides extend in the left-right direction. The upper housing 801 is provided with two standing portions 802A and a bridge portion 802B. The two standing portions 802A each extend upward from both the left and right end portions of the lower housing 803. The bridge portion 802B is provided bridging between each of the upper end portions of the two standing portions 802A. Each of the two standing portions 802A covers a side plate portion 11 (to be explained later, refer to FIG. 4 and FIG. 5) from the outside in the left and right directions. The bridge portion 802B covers, from above, a film cassette 21 (to be explained later, refer to FIG. 4 and FIG. 5).

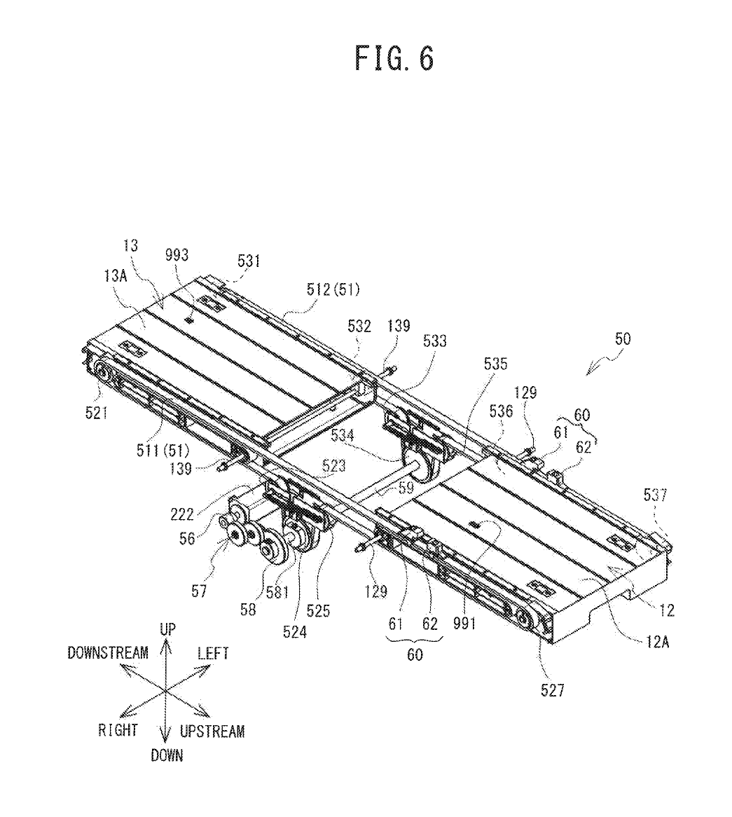

Inside the housing 800, a base transit portion 805 is formed, surrounded by the lower housing 803, the two standing portions 802A and the bridge portion 802B. The base transit portion 805 is an internal area of the housing 800 along which the base 2 that is attached to conveyance portions 60 (to be explained later, refer to FIG. 6) can pass when the conveyance portions 60 are conveyed by a conveyance mechanism 50 (to be explained later, refer to FIG. 6).

(1) Receiving Trays 12 and 13

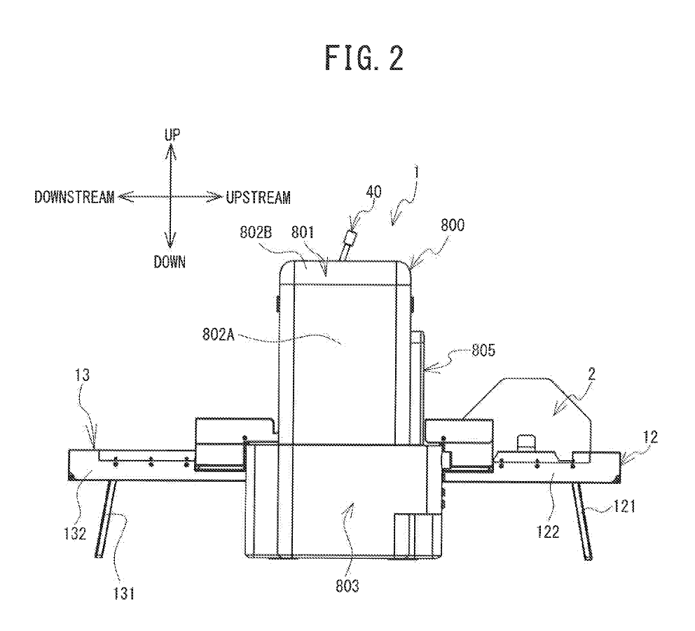

As shown in FIG. 1 and FIG. 2, a receiving tray 12 extends horizontally from the upper end portion of the side face of the lower housing 803 on the upstream side, toward the upstream side. A receiving tray 13 extends horizontally from the upper end portion of the side face of the lower housing 803 on the downstream side, toward the downstream side. In a plan view, the receiving trays 12 and 13 have a substantially rectangular box shape whose long sides extend in the conveyance direction. A leg portion 121 is provided on the lower side of the receiving tray 12 and supports the receiving tray 12 from underneath. A leg portion 131 is provided on the lower side of the receiving tray 13 and supports the receiving tray 13 from underneath. The top surface of the first receiving tray 12 receives the base 2 that is being conveyed toward the base transit portion 805. The top surface of the receiving tray 13 receives the base 2 and the object 3 that are packaged. Hereinafter, the top surface of the receiving tray 12 is called a “receiving surface 12A” and the top surface of the receiving tray 13 is called a “receiving surface 13A.” In a state in which each of the receiving trays 12 and 13 extends in the horizontal direction, each of the receiving surfaces 12A and 13A is horizontal.

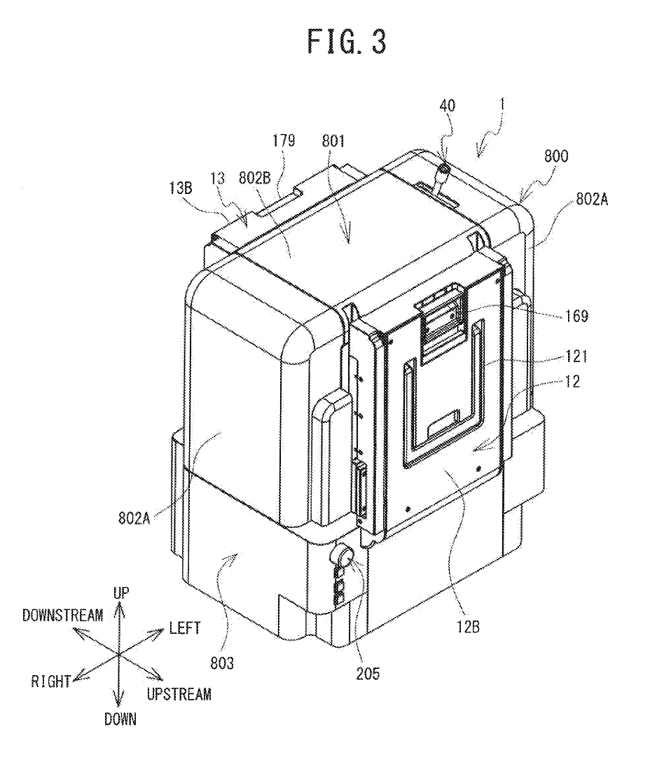

The receiving tray 12 can swing with its downstream end serving as a pivot point, and the receiving tray 13 can swing with its upstream end serving as a pivot point. FIG. 3 shows a state in which the receiving trays 12 and 13 are extending vertically. In this state, the receiving surfaces 12A and 13A are close to the side plate portions 11 (refer to FIG. 4 and FIG. 5) that support the receiving trays 12 and 13, and are vertical. On the receiving tray 12, a handle 169 is provided on a rear surface 12B that is the surface on the opposite side of the receiving surface 12A. On the receiving tray 13, a handle 179 is provided on a rear surface 13B that is the surface on the opposite side of the receiving surface 13A.

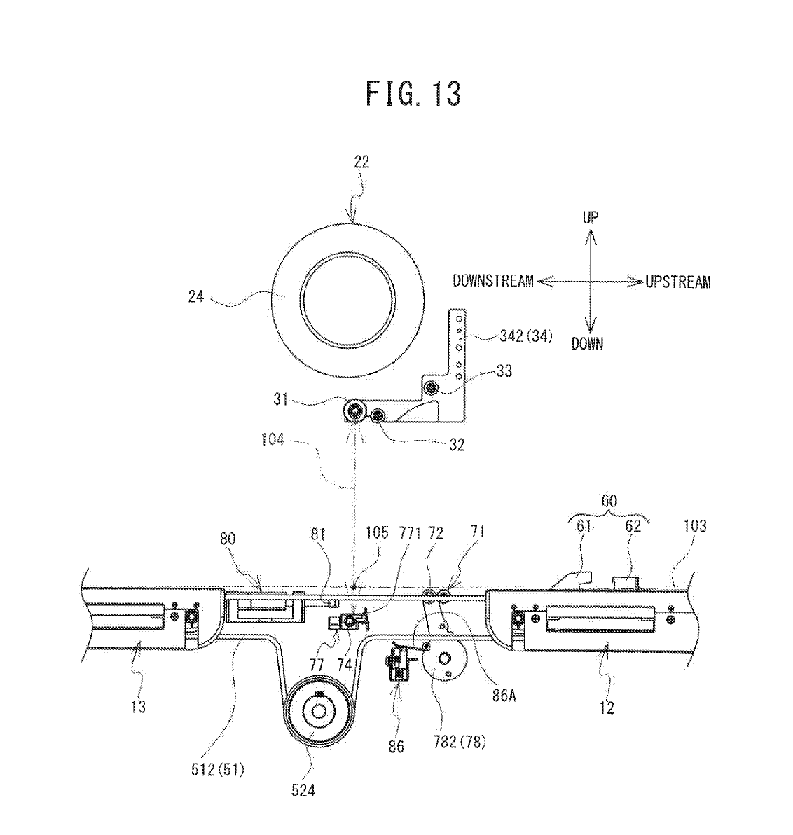

As shown in FIG. 2, a user grasps each of the handles 169 and 179 and manually causes the receiving trays 12 and 13 to swing, thus switching the receiving surfaces 12A and 13A to each become horizontal. In this manner, the packaging device 1 is in a state in which it is possible to package the base 2 and the object 3. The receiving surfaces 12A and 13A form the same plane, and thus the base 2 can be smoothly conveyed. Hereinafter, a path section along which the base 2 is conveyed on the plane that is formed by the receiving surfaces 12A and 13A is called a “conveyance path 103” (refer to FIG. 13). As shown in FIG. 3, the user can switch each of the receiving surfaces 12A and 13A to be vertical by manually swinging the receiving trays 12 and 13. The receiving trays 12 and 13 block the base transit portion 805. In this way, it is possible to install the packaging device 1 in a smaller space and to create a state in which the packaging device 1 can easily be carried around.

As shown in FIG. 4 and FIG. 5, the packaging device 1 is provided with a bottom portion 10 and side plate portions 111 and 112. The bottom portion 10 is rectangular in a plan view. The side plate portion 111 extends vertically upward from the right end portion of the bottom portion 10. The side plate portion 112 extends vertically upward from the left end portion of the bottom portion 10. Hereinafter, the side plate portions 111 and 112 are collectively called the “side plate portions 11.” The side plate portions 11 are shaped as substantially rectangular plates whose long sides extend in the up-down direction. The inner surfaces of the side plate portions 111 and 112 face each other. A pivot shaft 129 (refer to FIG. 6) is provided in a section of the receiving tray 12 that is close to the side plate portions 11, the pivot shaft 129 penetrating through the receiving tray 12 in the left-right direction. Both the left and the right ends of the pivot shaft 129 are supported by the side plate portions 11. The receiving tray 12 pivots around the pivot shaft 129. A pivot shaft 139 (refer to FIG. 6) is provided in a section of the receiving tray 13 that is close to the side plate portions 11, the pivot shaft 139 penetrating through the receiving tray 13 in the left-right direction. Both the left and the right ends of the pivot shaft 139 are supported by the side plate portions 11. The receiving tray 13 pivots around the pivot shaft 139.

(2) Conveyance Mechanism 50

As shown in FIG. 6, belts 511 and 512 are respectively provided on the right edges and the left edges of the receiving trays 12 and 13. Hereinafter, the belts 511 and 512 are also collectively called “belts 51.” The belts 51 are endless and have teeth on the inner side surface. The belt 511 is routed around a plurality of pulleys 521, 523, 524, 525 and 527, which can rotate around the left-right direction. The belt 512 is routed around a plurality of pulleys 531, 533, 534, 535 and 537, which can rotate around the left-right direction. Hereinafter, for ease of explanation, an explanation will be made of an example in which the receiving surfaces 12A and 13A are in the horizontal state.

As shown in FIG. 4 and FIG. 5, each of sections of the belts 51 that are positioned on the left and right edges of the receiving tray 12 are covered by a pair of covers 122 from the outside. Each of sections of the belts 51 that are positioned on the left and right edges of the second receiving tray 13 are covered by a pair of covers 132 from the outside. The respective covers 122 and 132 do not cover the side of the receiving surfaces 12A and 13A and thus the belts 51 are exposed on the side of the receiving surfaces 12A and 13A. In FIG. 6, the covers 122 and 132 are omitted.

As shown in FIG. 6, the pulley 521 is rotatably provided on the downstream side of the right side surface of the receiving tray 13. The pulley 527 is rotatably provided on the upstream side of the right side surface of the receiving tray 12. The pulleys 521 and 527 come into contact with the inner side of the belt 511 and rotatably support the belt 511. The pulleys 523 and 525 are respectively provided on the downstream side and the upstream side of the left side face of the side plate portion 111 (refer to FIG. 4). The pulleys 523 and 525 come into contact with the outer side of the belt 511 and rotatably support the belt 511. The pulley 524 is provided substantially in the center, in the conveyance direction, of the left side face of the side plate portion 111 (refer to FIG. 4 and FIG. 5). The pulley 524 comes into contact with the inner side of the belt 511. The pulley 524 has teeth on its outer side surface, and the teeth of the pulley 524 engage with the teeth on the inner side of the belt 511.

Note that the shape and arrangement of the pulleys 531, 533, 534, 535 and 537 provided on the left side of the receiving trays 12 and 13 are, respectively, the same shape and arrangement as the above-described pulleys 521, 523, 524, 525 and 527.

The pulleys 524 and 534 are connected by a shaft 59 that extends in the left-right direction. A shaft 581 extends to the right from the right side surface of the pulley 524. A spur gear 58 is provided on the outer end of the shaft 581. A second motor 222 is provided below the upstream side section of the receiving tray 13. A rotating shaft of the second motor 222 extends to the right. A spur gear 56 is provided on the leading end of the rotating shaft of the second motor 222. A transmission portion 57, which is formed by a plurality of spur gears, is provided between the spur gears 56 and 58. The transmission portion 57 transmits the rotational driving force of the spur gear 56 to the spur gear 58.

The pulley 524 is caused to rotate by transmitting the rotational driving force of the second motor 222 to the pulley 524 via the spur gears 56 and 58 and the transmission portion 57. The pulleys 524 and 534 are connected by the shaft 59, so when the pulley 524 rotates, the pulley 534 also rotates. The pulleys 524 and 534 respectively rotate the belts 511 and 512. The belts 51 convey the conveyance portions 60 from the upstream side to the downstream side by rotating in the counterclockwise direction in a right side view. Hereinafter, the belts 51, the conveyance portions 60, the second motor 222 and the transmission portion 57 are collectively called the “conveyance mechanism 50.”

The conveyance portion 60 will be explained. As shown in FIG. 6, the conveyance portion 60 is provided on the outer side surface of each of the belts 511 and 512, and the base 2 can be removably mounted on the conveyance portions 60. Each of the conveyance portions 60 is provided with a first conveyance portion 61 and a second conveyance portion 62. The first conveyance portion 61 and the second conveyance portion 62 are separated from each other in the direction in which the belt 51 extends, that is, in the conveyance direction.

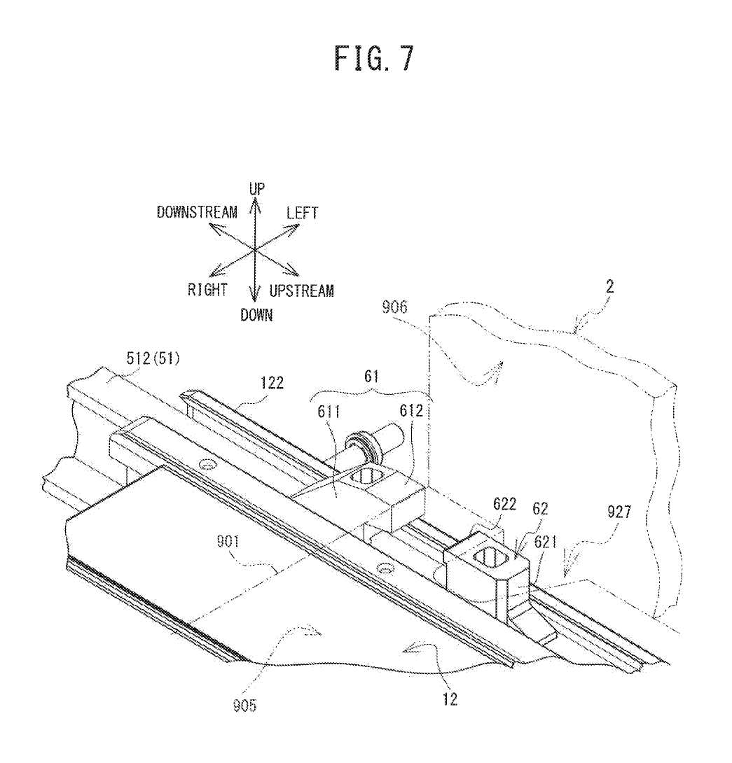

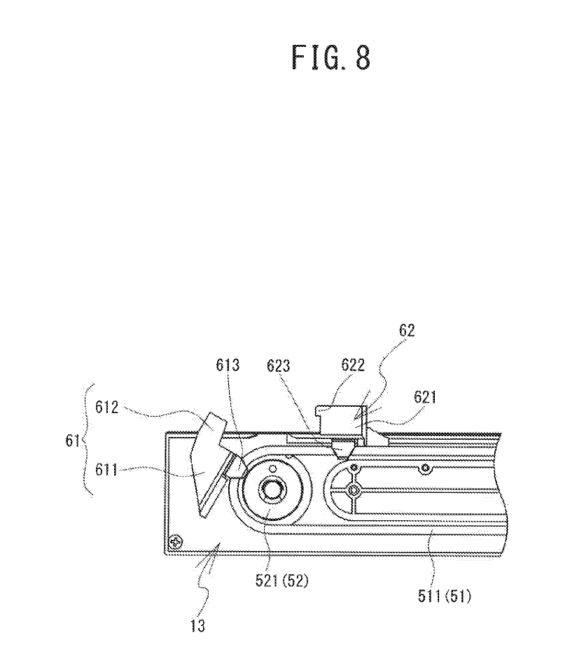

As shown in FIG. 7 and FIG. 8, the first conveyance portion 61 is provided with a first protruding portion 611, a first extending portion 612, and a claw portion 613. The first protruding portion 611 protrudes vertically and outwardly with respect to the outer side surface of the belt 51. The first extending portion 612 extends from the upper end portion of the first protruding portion 611 toward the upstream side, extending in parallel to the belt 51. A space is formed in the area between the belt 51 and the first extending portion 612. A part of the side surface of the first conveyance portion 61 on the upstream side that is close to the belt 51 has a shape that is recessed in the downstream direction. The claw portion 613 is provided on a section of the first protruding portion 611 that is on the side on which the first protruding portion 611 comes into contact with the belt 51. The first conveyance portion 61 is fixed to the belt 51 by the claw portion 613 clamping the belt 51.

The second conveyance portion 62 is provided with a second protruding portion 621, a second extending portion 622, and a claw portion 623. The second protruding portion 621 protrudes vertically and outwardly with respect to the outer side surface of the belt 51. The second extending portion 622 extends from the upper end portion of the second protruding portion 621 toward the downstream side, extending in parallel to the belt 51. A space is formed in the area between the belt 51 and the second extending portion 622. A part of the side surface of the second conveyance portion 62 on the downstream side that is close to the belt 51 has a shape that is recessed in the upstream direction. The claw portion 623 is provided on a section of the second protruding portion 621 that is on the side on which the second protruding portion 621 comes into contact with the belt 51. The second conveyance portion 62 is fixed to the belt 51 by the claw portion 623 clamping the belt 51.

The conveyance path 103 will be explained. The conveyance portions 60 move along the conveyance path 103 in accordance with the rotation of the belts 51. At this time, the base 2 that is attached to the conveyance portions 60 also moves along the conveyance path 103. Thus, the conveyance path 103 defines not only a path portion of the base 2, but is also equivalent to a path portion of the conveyance portions 60. The conveyance path 103 includes first to fifth positions, as positions of the conveyance portions 60.

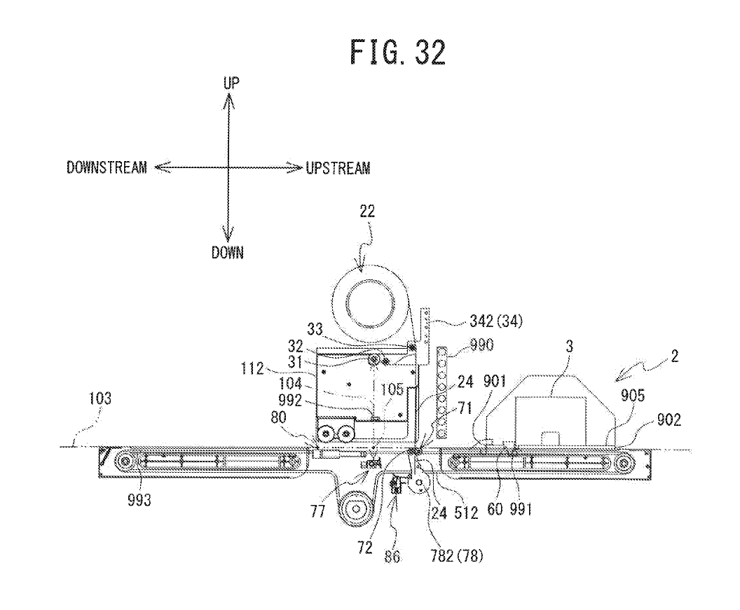

FIG. 7, and FIG. 32 that will be explained later, show a state in which the conveyance portion 60 is in the first position. The first position is a position of the conveyance portions 60 in which the base 2 before being packaged by the film 24 is attached to the conveyance portions 60. The first position is an original position of the conveyance portions 60, in which the conveyance portions 60 protrude upward from the receiving surface 12A of the receiving tray 12 and the user can attach the base 2 to the receiving surface 12A. The conveyance portions 60 in the first position are arranged such that they are on the upstream side of the base transit portion 805 and slightly on the downstream side of the center portion of the receiving tray 12 in the conveyance direction. A position of the base 2 that is attached to the conveyance portions 60 in the first position is called a start position. The start position is a position of the base 2 in which the base 2 is arranged before being packaged by the film 24. The base 2 in the start position is arranged on top of the receiving surface 12A in a state of being separated from the base transit portion 805 to the upstream side.

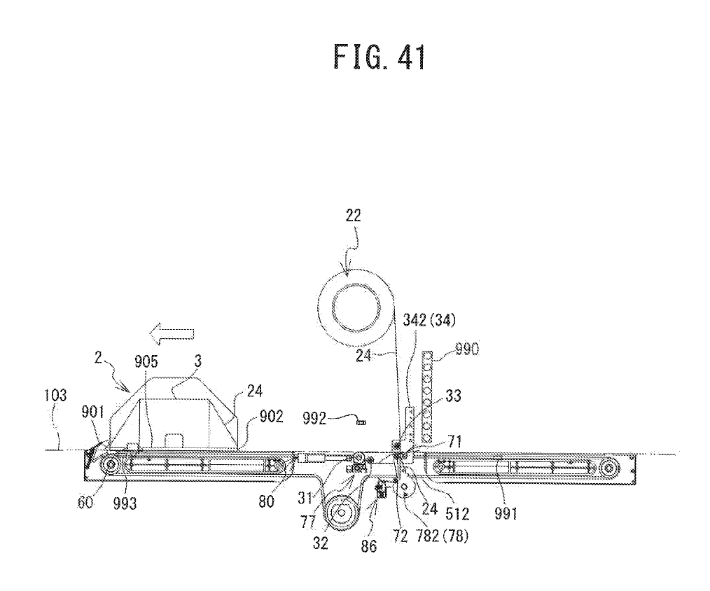

FIG. 8, and FIG. 41 that will be explained later, show a state in which the conveyance portion 60 is in the second position. The second position is a position of the conveyance portions 60 in which the base 2 after being packaged by the film 24 is removed from the conveyance portions 60. When the conveyance portions 60 are in the second position, the conveyance portions 60 protrude upward from the receiving surface 13A and the user can remove the base 2 from the receiving surface 13A. The conveyance portions 60 in the second position are arranged on the downstream side of the base transit portion 805 and in the vicinity of the downstream side end portion of the receiving tray 13. A position of the base 2 that is attached to the conveyance portions 60 in the second position is called an end position. The end position is a position of the base 2 in which the base 2 is arranged after being packaged by the film 24. The base 2 in the end position is arranged on top of the receiving surface 13A in a state of being separated from the base transit portion 805 to the downstream side.

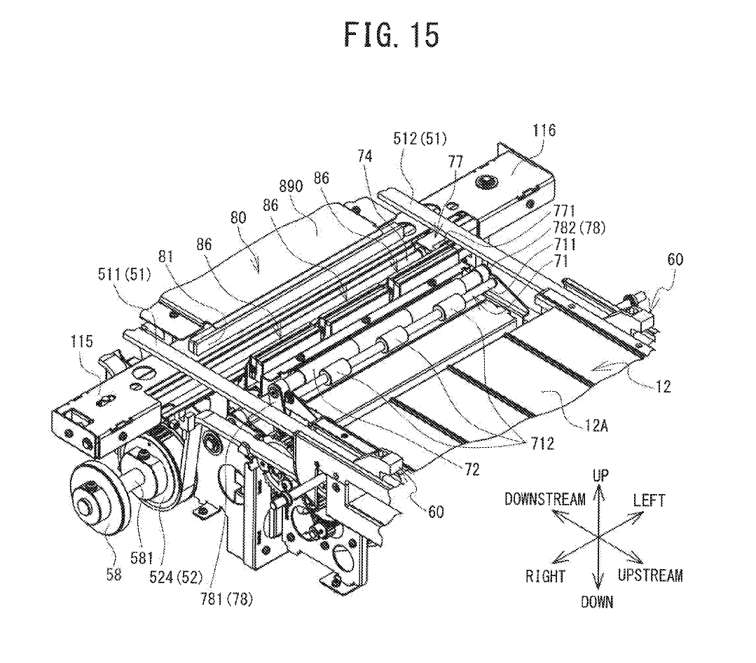

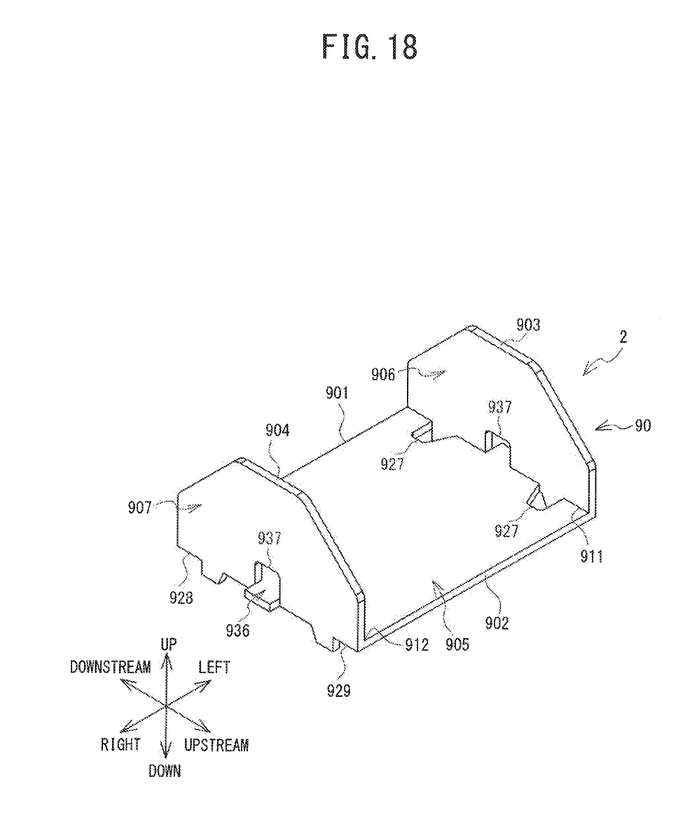

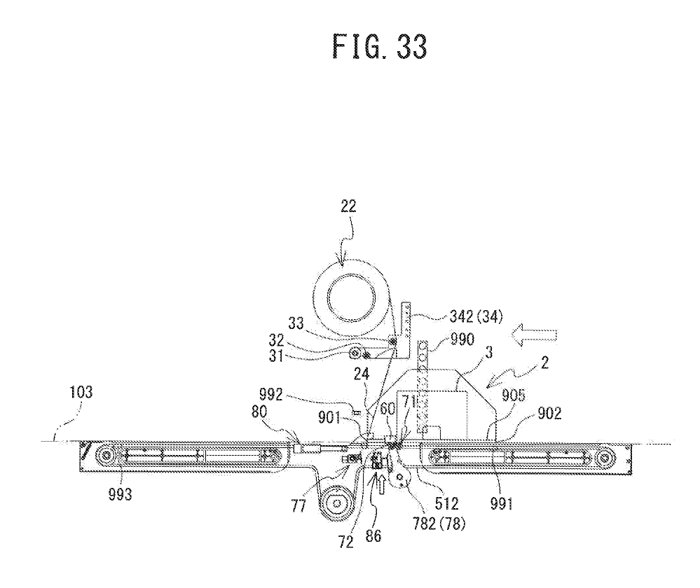

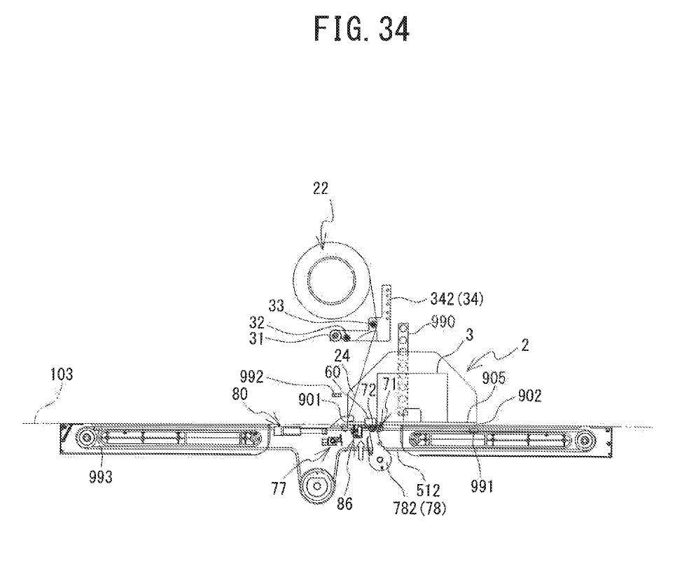

FIG. 33 and FIG. 34, which will be explained later, show a state in which the conveyance portion 60 is in the third position. The third position is a position of the conveyance portions 60 in which a heating portion 86 to be explained later (refer to FIG. 15) can bond the film 24 to a first base end portion 928 (refer to FIG. 18) that is the downstream side end of the base 2. The conveyance portions 60 in the third position are arranged inside the base transit portion 805 and slightly on the upstream side from roughly the center of the base transit portion 805 in the conveyance direction. The position of the base 2 that is attached to the conveyance portion 60 in the third position is called a front end bonding position. The front end bonding position is a position of the base 2 in which the heating portion 86 can bond the film 24 to the first base end portion 928. When the base 2 is in the front end bonding position, the downstream side portion of the base 2 is arranged inside the base transit portion 805.

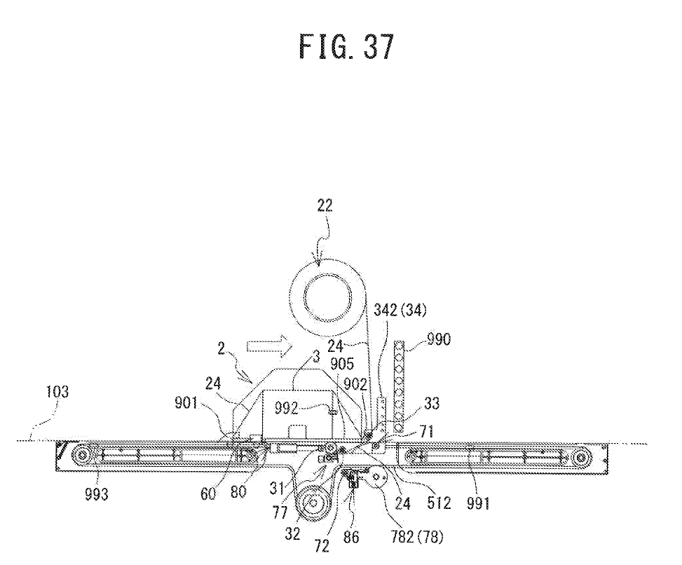

FIG. 37 to FIG. 40, which will be explained later, show a state in which the conveyance portion 60 is in the fourth position. The fourth position is a position of the conveyance portions 60 in which the heating portion 86 to be explained later (refer to FIG. 15) can bond the film 24 to a second base end portion 929 (refer to FIG. 18) that is the upstream side end of the base 2. The conveyance portions 60 in the fourth position are arranged to the downstream side of the base transit portion 805, and in the vicinity of the upstream side end of the receiving tray 13. The position of the base 2 that is attached to the conveyance portions 60 in the fourth position is called a rear end bonding position. The rear end bonding position is a position of the base 2 in which the heating portion 86 can bond the film 24 to the second base end portion 929. When the base 2 is in the rear end bonding position, substantially the whole of the base 2 is arranged inside the base transit portion 805.

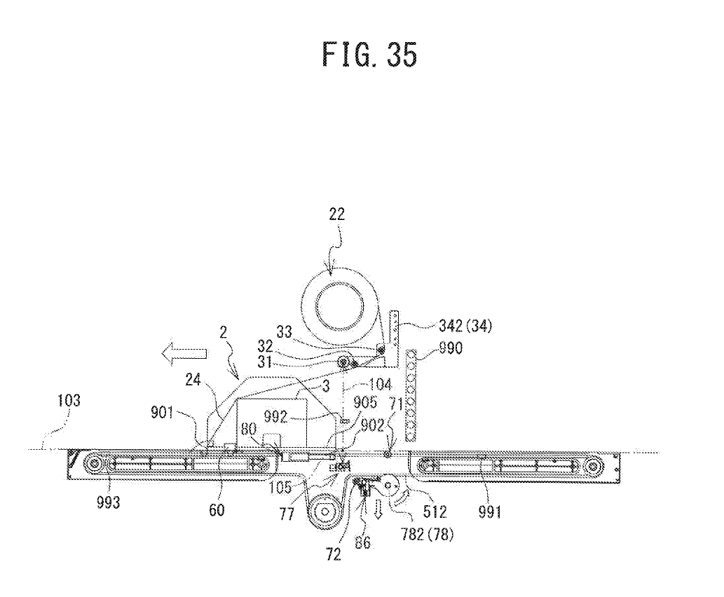

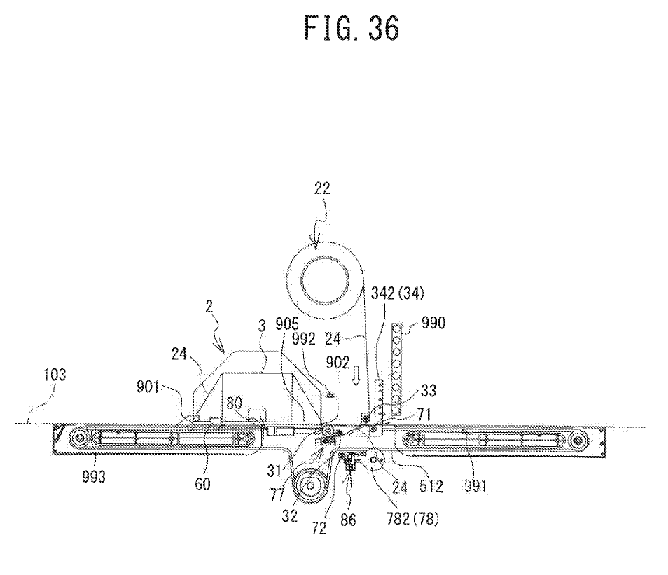

FIG. 35 and FIG. 36, which will be explained later, show a state in which the conveyance portion 60 is in the fifth position. The fifth position is a position of the conveyance portions 60 in which the conveyance portions 60 do not interfere with a raising and lowering operation of support portions 34 to be explained later (refer to FIG. 13). The conveyance portions 60 in the fifth position protrude upward from the receiving surface 13A of the receiving tray 13, and the conveyance portions 60 are adjacent to the downstream side end of the base transit portion 805. The position of the base 2 attached to the conveyance portions 60 in the fifth position is called an avoidance position. The avoidance position is a position of the base 2 in which the whole of the base 2 is arranged further to the downstream side than a movement path 104 (refer to FIG. 13) that will be explained later. When the base 2 is in the avoidance position, the upstream side portion of the base 2 is arranged inside the base transit portion 805.

Positional relationships of the first to fifth positions (that is, positional relationships between the start position, the end position, the front end bonding position, the rear end bonding position and the avoidance position) can be defined in the following manner. The downstream side of the conveyance direction is a direction from the first position (the start position) toward the second position (the end position). The upstream side of the conveyance direction is a direction from the second position (the end position) toward the first position (the start position). The third to fifth positions (the front end bonding position, the rear end bonding position and the avoidance position) are positioned between the first position (the start position) and the second position (the end position). The fifth position (the avoidance position) is positioned further to the downstream side than the fourth position (the rear end bonding position). The third position (the front end bonding position) is positioned further to the upstream side than the fourth position (the rear end bonding position). In the present embodiment, the distance between the first position and the second position is 640.0 mm. Note that, when the base 2 that is attached to the conveyance portions 60 is conveyed from the start position to the front end bonding position, the base 2 can enter into the base transit portion 805.

(3) Film Cassette 21

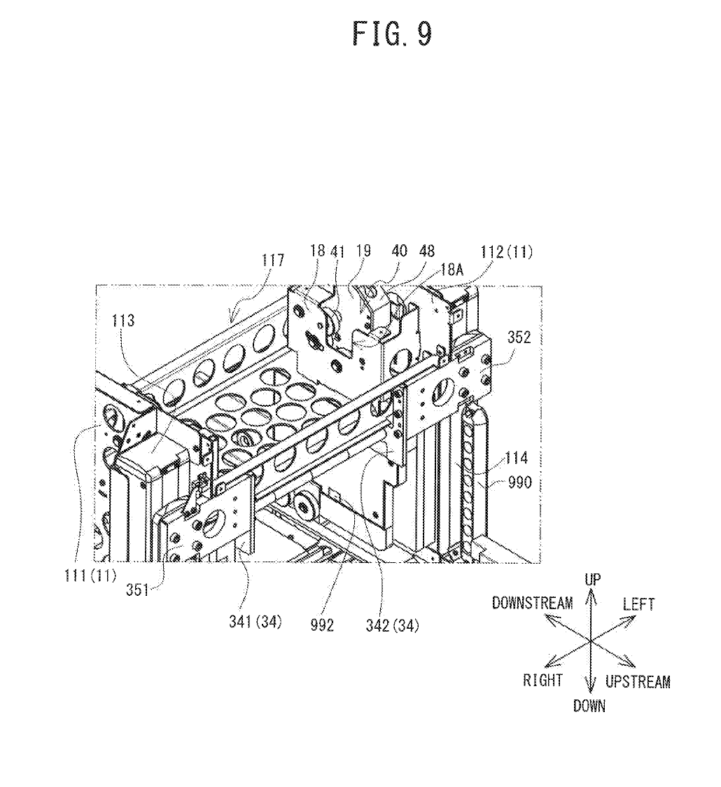

As shown in FIG. 9, a plate-shaped bridge plate 117 is mounted between the upper ends of each of the side plate portions 111 and 112. A torque adjustment mechanism 40 (to be explained later) is provided on the upper side of the bridge plate 117 and on the right side face of the side plate portion 112. The torque adjustment mechanism 40 is supported on the left side of a support plate 19 that extends in parallel with the side plate portion 112. Of a wall plate 18 that covers the upstream side, the downstream side and the right side of the torque adjustment mechanism 40, a recessed portion 18A that is recessed downward is provided on the upper end of the portion that covers the right side of the torque adjustment mechanism 40.

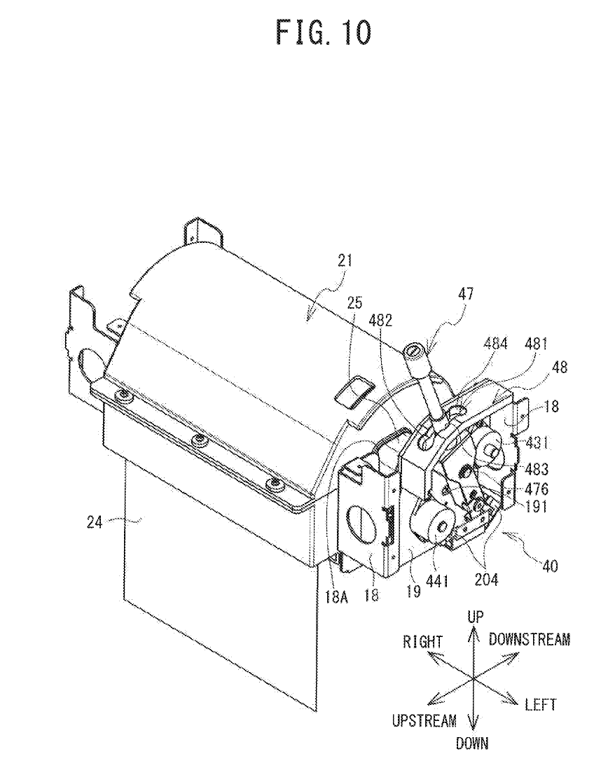

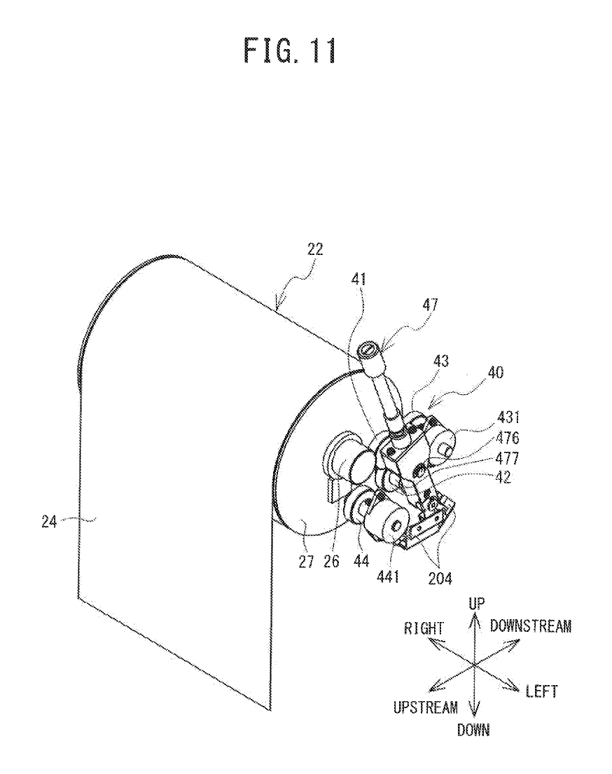

As shown in FIG. 10, the film cassette 21 has a substantially cylindrical shape. The film cassette 21 internally contains a film roll 22 (refer to FIG. 11) having a shaft around which the film 24 is wound. A discharge opening (not shown in the drawings) is provided below the film cassette 21. The discharge opening extends across the width of the film 24 that is wound around the film roll 22. The film 24 that is fed out from the film roll 22 is discharged downward from the discharge opening.

Of two side walls of the film cassette 21 that are orthogonal to the axis line direction of the film cassette 21, a protruding portion 25 is provided on the side wall that is arranged on the left side in a state in which the film cassette 21 is mounted in the packaging device 1. The protruding portion 25 has a prism shape. The protruding portion 25 extends to the left along the axis line of the film cassette 21. The film cassette 21 is mounted on the bridge plate 117 such that the protruding portion 25 fits into the recessed portion 18A (refer to FIG. 9) of the wall plate 18.

As shown in FIG. 11, flanges 27 are provided on both ends, respectively, of the shaft of the film roll 22. Of the two flanges 27, a film gear 26 is provided on the flange 27 that is arranged on the left side in a state in which the film cassette 21 is mounted in the packaging device 1. The film gear 26 extends to the left along the axis line of the shaft of the film roll 22. The film gear 26 is arranged inside the protruding portion 25 (refer to FIG. 10). A part of the film gear 26 is exposed from a hole (not shown in the drawings) that is provided in the protruding portion 25. The film gear 26 rotates as the film 24 is fed out from the film roll 22.

(4) Torque Adjustment Mechanism 40

As shown in FIG. 10 and FIG. 11, the torque adjustment mechanism 40 is provided with a first gear 41, a second gear 42, a third gear 43, a fourth gear 44, a first load 431, a second load 441, a lever 47 and so on. The first gear 41 to the fourth gear 44 are spur gears. The first load 431 and the second load 441 are clutch springs.

The lever 47 is arranged to the left side of the support plate 19. A pivot shaft 476 that extends horizontally to both sides in the left-right direction from the support plate 19 is inserted through the lever 47. A plate-shaped fixing portion 48 is supported by the left side of the support plate 19. A through hole 481 through which the lever 47 is inserted is provided on the fixing portion 48. The lever 47 can swing around the pivot shaft 476 on the inner side of the through hole 481. The angle of the lever 47 can be changed to three different inclined angles, by being positioned by one of three circular holes 482, 483 and 484 that are included in the through hole 481.

The first gear 41 is arranged on the right side of the support plate 19. The first gear 41 is rotatably supported on the pivot shaft 476. The first gear 41 and the lever 47 face each other with the support plate 19 between them. The first gear 41 does not swing even when the lever 47 swings around the pivot shaft 476. The second gear 42 is arranged on the right side of the support plate 19. A rotating shaft 477 extends from the lower end of the lever 47 in parallel with the pivot shaft 476. The rotating shaft 477 is located lower than the pivot shaft 476 and rotatably supports the second gear 42. The rotating shaft 477 penetrates through a long hole 191 that is provided in the support plate 19 and protrudes to the right side, and is coupled to the second gear 42. The second gear 42 and the lever 47 face each other with the support plate 19 between them. The second gear 42 swings in accordance with the lever 47 when the lever 47 swings around the pivot shaft 476. The diameter of the second gear 42 is substantially the same as the diameter of the first gear 41.

The first gear 41 and the second gear 42 mesh with each other. The distance between the pivot shaft 476 and the rotating shaft 477 remains constant even when the lever 47 swings, and thus the first gear 41 and the second gear 42 are constantly in a state of being meshed together. It should be noted that, when the film cassette 21 is mounted in the packaging device 1, the first gear 41 fits with the film gear 26 that is exposed from the hole provided in the protruding portion 25. When the film gear 26 rotates due to the film 24 being fed out from the film roll 22, the first gear 41 rotates. The second gear 42 rotates in accordance with the rotation of the first gear 41.

The third gear 43 is provided on the downstream side of the first gear 41. The fourth gear 44 is provided below the film gear 26 when the film cassette 21 is mounted in the packaging device 1. The third gear 43 and the fourth gear 44 are arranged on the right side of the support plate 19. The diameters of the third gear 43 and of the fourth gear 44 are substantially the same as the diameters of the first gear 41 and the second gear 42. A rotating shaft of the third gear 43 penetrates through a hole provided in the support plate 19 and extends horizontally to the left, and is connected to the first load 431. A rotating shaft of the fourth gear 44 penetrates through a hole provided in the support plate 19 and extends horizontally to the left, and is connected to the second load 441. The first load 431 and the second load 441 respectively apply torque to the third gear 43 and the fourth gear 44. The strength of the torque applied by the second load 441 to the fourth gear 44 is larger than the strength of the torque applied by the first load 431 to the third gear 43.

A state in which the lever 47 is positioned by the circular hole 483 as shown in FIG. 10 is called a first state. When the lever 47 is in the first state, the second gear 42 meshes with neither the third gear 43 nor the fourth gear 44. The torque applied to the third gear 43 by the first load 431 and the torque applied to the fourth gear 44 by the second load 441 are not transmitted to the film gear 26. Thus, a tension exerted on the film 24 that is fed out from the film roll 22 is at its smallest. As an example, when the lever 47 is in the first state, the tension exerted on the film 24 is “1.0” (the unit is kilogram-force).

When the lever 47 is swung to the upstream side from the state shown in FIG. 10, the lever 47 is positioned by the circular hole 482. A state in which the lever 47 is positioned by the circular hole 482 is called a second state. When the lever 47 is in the second state, the second gear 42 meshes with the third gear 43. The fourth gear 44 does not mesh with the second gear 42. The torque applied to the third gear 43 by the first load 431 is transmitted via the second gear 42 to the first gear 41. Thus, by a small amount of torque being applied to the film gear 26 via the first gear 41, the tension exerted on the film 24 that is fed out from the film roll 22 is larger than when in the first state. As an example, when the lever 47 is in the second state, the tension exerted on the film 24 is “3.5” (the unit is kilogram-force).

When the lever 47 is swung to the downstream side from the state shown in FIG. 10, the lever 47 is positioned by the circular hole 484. A state in which the lever 47 is positioned by the circular hole 484 is called a third state. When the lever 47 is in the third state, the second gear 42 meshes with the fourth gear 44. The third gear 43 does not mesh with the second gear 42. The torque applied to the fourth gear 44 by the second load 441 is transmitted via the second gear 42 to the first gear 41. Thus, by a large amount of torque being applied to the film gear 26 via the first gear 41, the tension exerted on the film 24 that is fed out from the film roll 22 is larger than when in the second state. As an example, when the lever 47 is in the third state, the tension exerted on the film 24 is “5.0” (the unit is kilogram-force).

(5) Movable Rollers 30

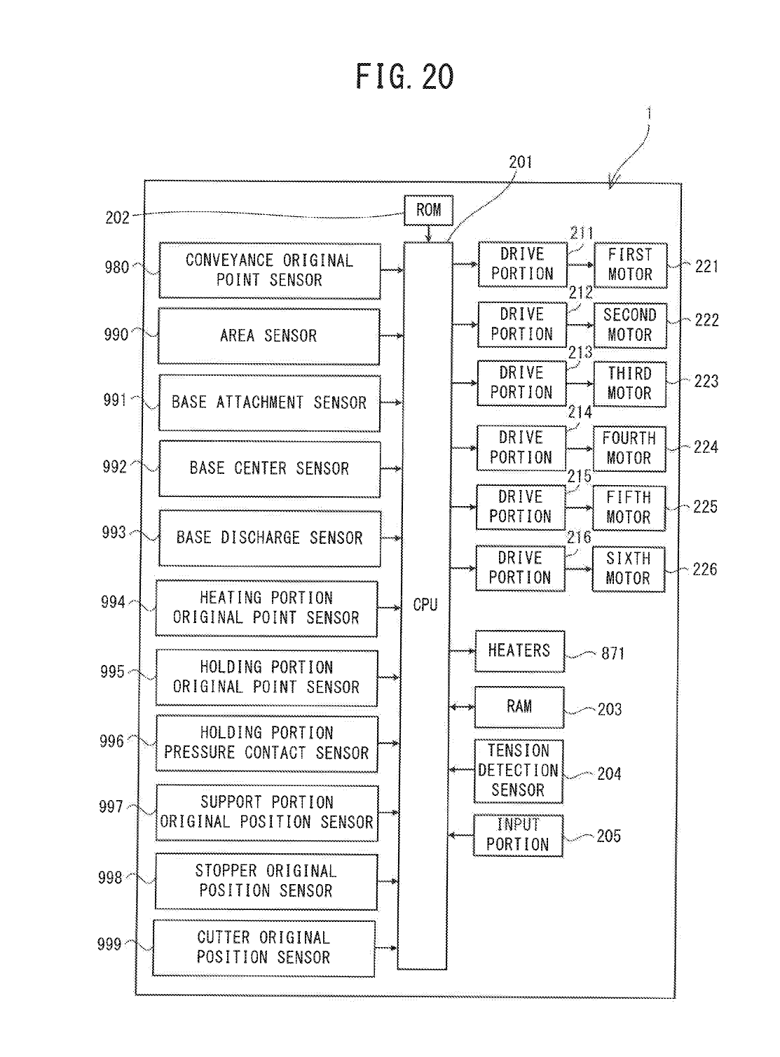

As shown in FIG. 4 and FIG. 5, a box-shaped protruding portion 113 that extends in the up-down direction is provided on the right side face of the side plate portion 111. A box-shaped protruding portion 114 that extends in the up-down direction is provided on the left side face of the side plate portion 112. A carriage (not shown in the drawings) that is driven by rotation of a first motor 221 (refer to FIG. 20) is provided inside each of the protruding portions 113 and 114. The carriage inside the protruding portion 113 connects to a support plate portion 351 at a section on the upstream side of the protruding portion 113. A support portion 341 is connected to the left side of the support plate portion 351. The carriage inside the protruding portion 114 connects to a support plate portion 352 at a section of the protruding portion 114 on the upstream side. The support plate portions 351 and 352 are plate-shaped. A support portion 342 is connected to the right side of the support plate portion 352.

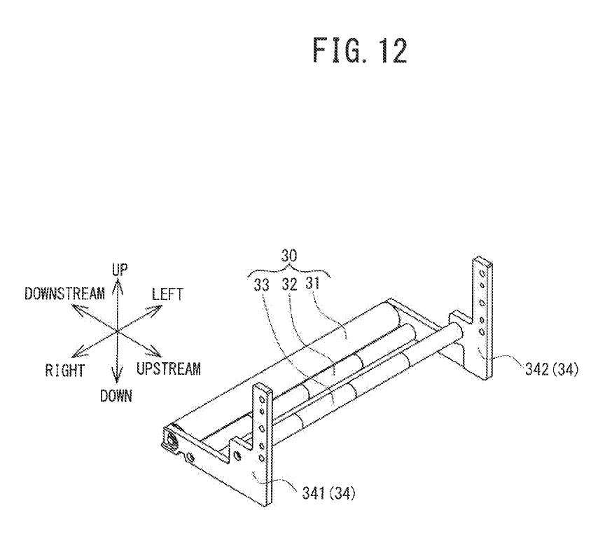

Hereinafter, the support portions 341 and 342 will also be collectively called “support portions 34.” The support portions 34 support a guide roller 31, a first auxiliary roller 32 and a second auxiliary roller 33 (refer to FIG. 12). Hereinafter, the guide roller 31, the first auxiliary roller 32 and the second auxiliary roller 33 are also collectively called the “movable rollers 30.” Via the carriages, the first motor 221 can move the support portions 34, which are connected, respectively, to the support plate portions 351 and 352, in the up-down direction.

As shown in FIG. 12, the movable rollers 30 have a columnar shape. The movable rollers 30 extend in the left-right direction. The length of the movable rollers 30 in the left-right direction is substantially the same as the lengths of the first receiving trays 12 and 13 (refer to FIG. 4 and FIG. 5) in the left-right direction. The support portions 341 and 342 support the movable rollers 30 such that they can rotate freely around their axes. The support portions 34 are plate-shaped members having a substantially reverse L shape in a right side view. The guide roller 31 is supported by each of the support portions 341 and 342 at the downstream end of the section of each of the support portions 341 and 342 that extends in the conveyance direction. The first auxiliary roller 32 is supported by each of the support portions 341 and 342 close to and on the upstream side of the position where the guide roller 31 is supported. The second auxiliary roller 33 is supported by each of the support portions 341 and 342 at a position where the section of each of the support portions 341 and 342 that extends in the conveyance direction intersects the section that extends in the up-down direction.

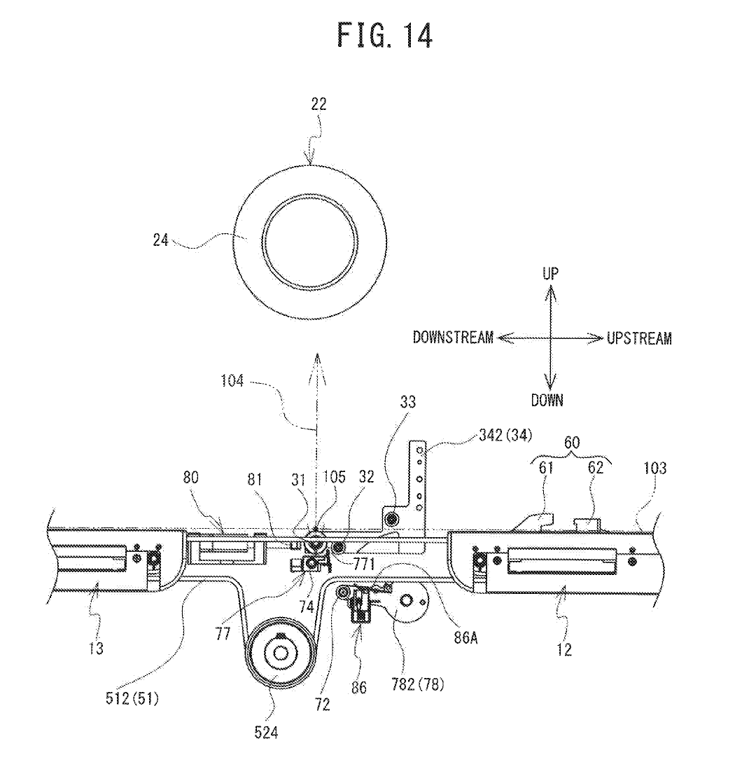

As shown in FIG. 13 and FIG. 14, the guide roller 31, the first auxiliary roller 32, and the second auxiliary roller 33 are disposed in that order from the downstream side to the upstream side. As shown in FIG. 4, the support portion 341 is fixed to the support plate portion 351 by a screw being tightened through a hole of the support portion 341. The support plate 342 is fixed to the support plate portion 352 by a screw being tightened through a hole of the support portion 342. The support portions 34 move in the up-down direction by the support plate portions 351 and 352 moving in the up-down direction.

The support portions 34 can move over a movable range of the support portions 34, the upper end of the movable range being the original position (refer to FIG. 13) and the lower end of the movable range being a lowered position (refer to FIG. 14). As shown in FIG. 13, when the support portions 34 have been moved to the original position, a section of each of the support portions 341 and 342 that extends in the up-down direction is arranged in the vicinity of the upstream side of the film cassette 21 (refer to FIG. 4) that houses the film roll 22. A section of each of the support portions 341 and 342 that extends in the conveyance direction is arranged below the film cassette 21. The movable rollers 30 are arranged below the film cassette 21. As shown in FIG. 14, when the support portions 34 have been moved to the lowered position, the section of each of the support portions 341 and 342 that extends in the conveyance direction is arranged below the conveyance path 103.

Hereinafter, a path of the guide roller 31 the moves in the up-down direction in accordance with the movement of the support portions 34 will be called a “movement path 104.” The guide roller 31 can move between an upper guide position and a lower guide position along the movement path 104. In the present embodiment, the distance between the upper guide position and the lower guide position is 161.5 mm. When the support portions 34 are in the original position, the guide roller 31 is in the upper guide position. When the guide roller 31 has been moved to the upper guide position, the guide roller 31 is arranged on a different side of the conveyance path 103 from the heating portion 86 (above the conveyance path 103 in the present embodiment). When the support portions 34 are in the lowered position, the guide roller 31 is in the lower guide position. When the guide roller 31 has been moved to the lower guide position, the guide roller 31 is arranged on the same side of the conveyance path 103 as the heating portion 86 (namely, below the conveyance path 103). The conveyance path 103 and the movement path 104 intersect. The position at which the conveyance path 103 and the movement path 104 intersect will be called an “intersection position 105.”

(6) Cutter 77

As shown in FIG. 15, a protruding portion 115 that protrudes to the right is provided on the right side face of the side plate portion 111 (refer to FIG. 4). A protruding portion 116 that protrudes to the left is provided on the left side face of the side plate portion 112 (refer to FIG. 4). A guide rail 74 extends between the protruding portions 115 and 116. The cutter 77 is provided on the guide rail 74. The cutter 77 is provided with a blade portion 771 that protrudes upward from the top surface of the cutter 77. The blade portion 771 extends in the left-right direction. The cutter 77 can move to the left and to the right along the guide rail 74.

A carriage (not shown in the drawings) is positioned on the downstream side of the guide rail 74. The carriage is connected to the cutter 77. The carriage is driven by a fifth motor 225 (refer to FIG. 20) that is provided inside the protruding portion 115. When the fifth motor 225 drives the carriage, the cutter 77 moves in the left-right direction along the guide rail 74. The left end of a movable range of the cutter 77 is a original position of the cutter 77. When the cutter 77 is in the original position, the blade portion 771 is arranged further to the left side than the left end of the film 24 that is housed in the film cassette 21.

As shown in FIG. 14, when the support portions 34 have been moved to the lowered position, the guide roller 31 has been moved to the lower guide position and is arranged above the guide rail 74. The blade portion 771 that extends upward from the cutter 77 is arranged between the guide roller 31 and the first auxiliary roller 32. In this state, when the cutter 77 moves along the guide rail 74 from the original position toward the right, the blade portion 771 can cut the film 24 in the width direction. In the present embodiment, the distance from the original position of the cutter 77 to the right end of the movable range is 244.5 mm.

(7) Base Guide Roller 71 and Holding Roller 72

As shown in FIG. 15, the base guide roller 71 is provided on the upstream side of the section between the side plate portions 111 and 112 (refer to FIG. 4 and FIG. 5) and below the conveyance path 103 (refer to FIG. 14). The base guide roller 71 is provided with a shaft portion 711 and a plurality of roller portions 712. The shaft portion 711 extends in the left-right direction. The plurality of the roller portions 712 are provided at equal intervals in the axial direction of the shaft portion 711. The plurality of the roller portions 712 are in contact with the conveyance path 103 from below. As the base 2 is conveyed from the upstream side to the downstream side along the conveyance path 103, the base guide roller 71 supports the base 2 from below between the receiving trays 12 and 13, and guides the base 2 from the receiving tray 12 to the receiving tray 13. As shown in FIG. 14, when the support portions 34 have been moved to the lowered position, the second auxiliary roller 33 is arranged in the vicinity of and above the base guide roller 71.

The holding roller 72 is provided on the downstream side of the base guide roller 71. The holding roller 72 is column-shaped. The holding roller 72 extends in the left-right direction. The right end of the holding roller 72 is rotatably supported by a holding portion 781. The left end of the holding roller 72 is rotatably supported by a holding portion 782. Hereinafter, the holding portions 781 and 782 will also be collectively called the “holding portions 78.” The holding portions 78 can rotate. The holding portions 78 are rotated by a sixth motor 226 (refer to FIG. 20).

As shown in FIG. 13 and FIG. 14, the rotation of the holding portions 78 switches the holding roller 72 between a pressure contact position in which the holding roller 72 is positioned close to the downstream side of the base guide roller 71 (refer to FIG. 13) and a original position in which the holding roller 72 has been moved downward, away from the base guide roller 71 (refer to FIG. 14). In the present embodiment, the distance between the original position and the bonding position over which the holding roller 72 moves is 38.0 mm. As shown in FIG. 13, when the holding portions 78 have been moved to the pressure contact position, the holding roller 72 is in contact with the conveyance path 103 from below. When the holding roller 72 is positioned close to the downstream side of the base guide roller 71, the film 24 that is discharged from the film cassette 21 (refer to FIG. 3 and FIG. 4) can be clamped and supported between the holding roller 72 and the base guide roller 71.

(8) Heating Portion 86

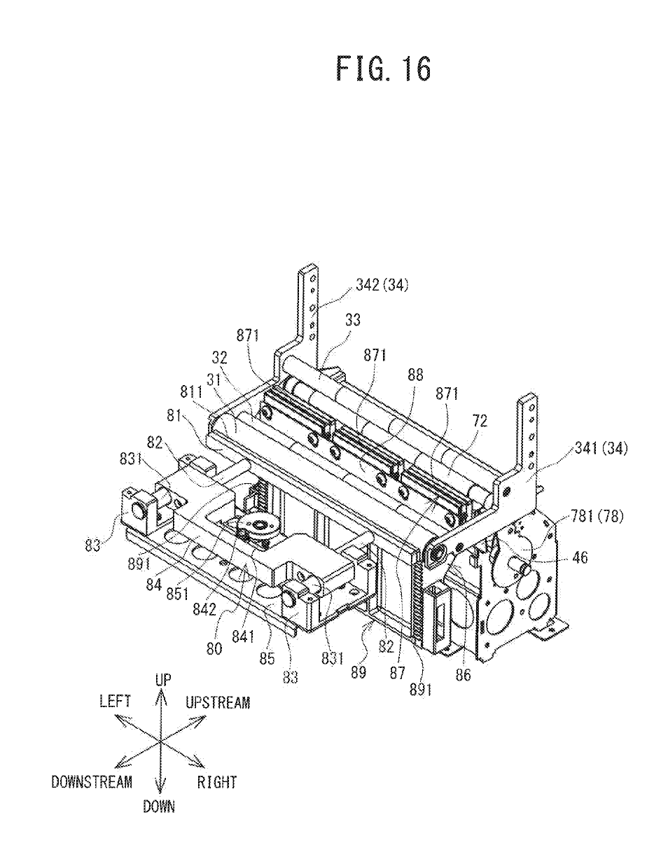

As shown in FIG. 15 and FIG. 16, the heating portion 86 is provided in the vicinity of the holding roller 72. The heating portion 86 is provided with three heating units 87, a holding portion 88 and a base portion 89. Heaters 871 are provided on the top surfaces of the heating units 87. The heaters 871 are formed of metal plates, and are resistance heating type heaters. The heaters 871 come into contact with the film 24 and heat the film 24. The holding portion 88 is a plate-shaped member that is bent in a substantially U shape in a side view, and internally holds the three heating units 87.

The base portion 89 supports the holding portion 88 from below. A rack gear 891 that extends in the up-down direction is provided on both the left and right ends of the side surfaces of the base portion 89 on the downstream side. Pinion gears are provided on a rotating shaft of a third motor 223 (refer to FIG. 20). The pinion gears engage with the rack gears 891. When the third motor 223 rotates, the base portion 89 moves in the up-down direction. In this manner, the holding portion 88 that is provided above the base portion 89 and the three heating units 87 that are held by the holding portion 88 also move in the up-down direction.

The heating portion 86 can move over a movable range of the heating portion 86, the upper end of the movable range being a heating position (refer to FIG. 15) and the lower end of the movable range being an original position (refer to FIG. 13 and FIG. 14). As shown in FIG. 15, when the heating portion 86 has been moved to the heating position, the top surface of each of the three heating units 87 comes close to the conveyance path 103. As shown in FIG. 13 and FIG. 14, when the heating portion 86 has been moved to the original position, the top surface of each of the three heating units 87 is spaced away from the conveyance path 103.

In the present embodiment, the distance between the original position and the heating position of the heating portion 86 is 59.2 mm. A stand-by position is positioned between the original position and the heating position of the heating portion 86. The stand-by position is a position of the heating portion 86 that is located slightly above an intermediate position between the original position and the heating position of the heating portion 86. The distance between the original position and the stand-by position of the heating portion 86 is 43.7 mm. The distance between the stand-by position and the heating position is 15.5 mm.

(9) Rotation Control Portion 80

As shown in FIG. 15 and FIG. 16, the rotation control portion 80 is provided on the downstream side of the heating portion 86. The upper side of the rotation control portion 80 is covered by a top plate 890. The rotation control portion 80 is provided with a base portion 85. The base portion 85 is provided above the bottom portion 10 (refer to FIG. 4) and is fixed in place in the section between the side plate portions 111 and 112 (refer to FIG. 4). A support portion 84 and two shaft support portions 83 are provided on the top surface of the base portion 85.

The support portion 84 is box-shaped and extends in the left-right direction. The central section of the support portion 84 in the left-right direction is recessed toward the downstream side. A plate 841 is provided such that it extends across the upstream side of the recessed section. A cylindrical protruding portion 842 protrudes upward from the central section, in the left-right direction, of the plate 841. Holes that penetrate through the support portion 84 in the conveyance direction are respectively provided in the left end and the right end of the support portion 84. Two support rods 82 extend in the upstream direction from the upstream side surfaces of the support portion 84. A stopper 81 is attached to the upstream ends of the two support rods 82. The stopper 81 has a rod shape whose cross-sectional shape is square. The stopper 81 extends in the left-right direction. A rubber strip 811 is provided on the upstream side surface of the stopper 81.

The two shaft support portions 83 are respectively provided on the left and right ends of the base portion 85. A shaft 831 that extends in the conveyance direction is provided on each of the two shaft support portions 83. Each of the shafts 831 passes through one of the holes provided in the support portion 84. The support portion 84 can move in the conveyance direction along the two shafts 831. Springs (not shown in the drawings) are respectively interposed between the shaft support portions 83 and the support portion 84. The springs energize the support portion 84 toward the upstream side.

A cam 851 is provided on the base portion 85. A fourth motor 224 (refer to FIG. 20) is provided below the base portion 85. The cam 851 is connected to a rotating shaft that extends upward from the fourth motor 224. The cam 851 is arranged on the upstream side of the plate 841, in the section of the support portion 84 that is recessed toward the downstream side. The downstream side of the outer circumferential surface of the cam 851 comes into contact with the protruding portion 842. When the cam 851 rotates due to the driving of the fourth motor 224, the support portion 84 moves in the conveyance direction. The stopper 81 that is connected to the support portion 84 also moves in the conveyance direction in accordance with the movement of the support portion 84.

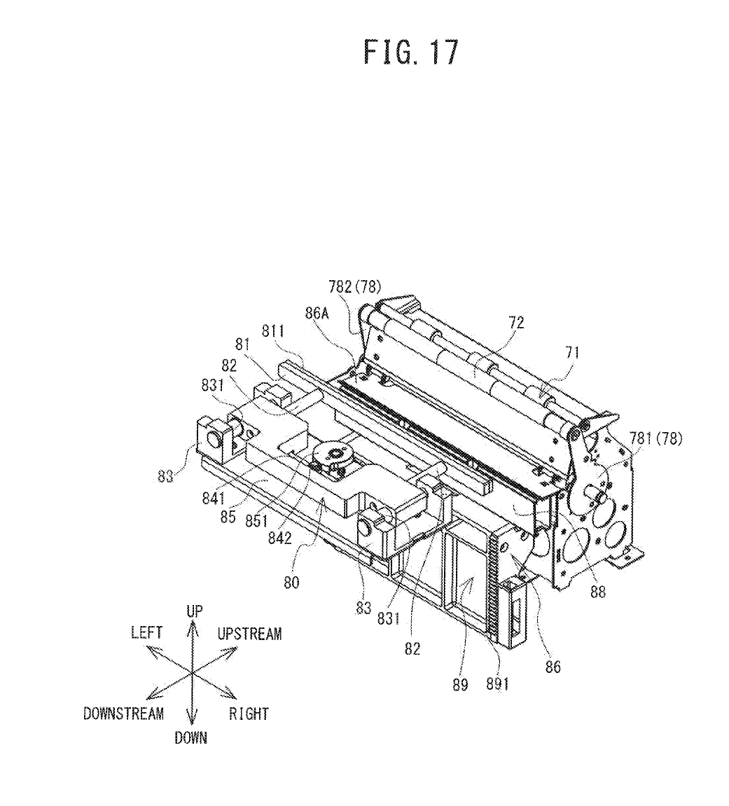

The stopper 81 can move over a movable range of the stopper 81, the upstream side end of the movable range being a regulating position (refer to FIG. 16) and the downstream side end of the movable range being a original position (refer to FIG. 17). In the present embodiment, when the cam 851 is at a predetermined reference angle, the stopper 81 is held in the original position. When the cam 851 rotates by 55 degrees from the predetermined reference angle, the stopper 81 is moved to the regulating position.

FIG. 16 shows a state in which the support portions 34 are in the lowered position, the holding portions 78 are in the pressure contact position, the heating portion 86 is in the heating position and the stopper 81 is in the regulating position. In this case, the heating units 87 of the heating portion 86 pass between the first auxiliary roller 32 and the holding roller 72 and protrude upward. The rubber strip 811 of the stopper 81 is located in a position where it can come into contact with the guide roller 31, and the rubber strip 811 is pressed to the side of the guide roller 31. The rotation of the guide roller 31 is inhibited by the frictional force between the rubber strip 811 and the guide roller 31. Specifically, the regulating position of the stopper 81 is a position in which the stopper 81 comes close to the guide roller 31 in the lower guide position and regulates the rotation of the guide roller 31.

When, in the state shown in FIG. 16, the stopper 81 is moved from the regulating position to the original position, the stopper 81 separates from the guide roller 31 and thus, the guide roller 31 can rotate. In other words, the original position of the stopper 81 is a position that allows the rotation of the guide roller 31, by the stopper 81 being separated from the guide roller 31 that is in the lower guide position. FIG. 17 shows a state in which the support portions 34 are in the original position, the holding portions 78 are in the pressure contact position, the heating portion 86 is in the original position and the stopper 81 is in the original position (refer to FIG. 13). The top surfaces of the three heating units 87 of the heating portion 86 that is in the original position are covered by a lid portion 86A.

(10) Base 2

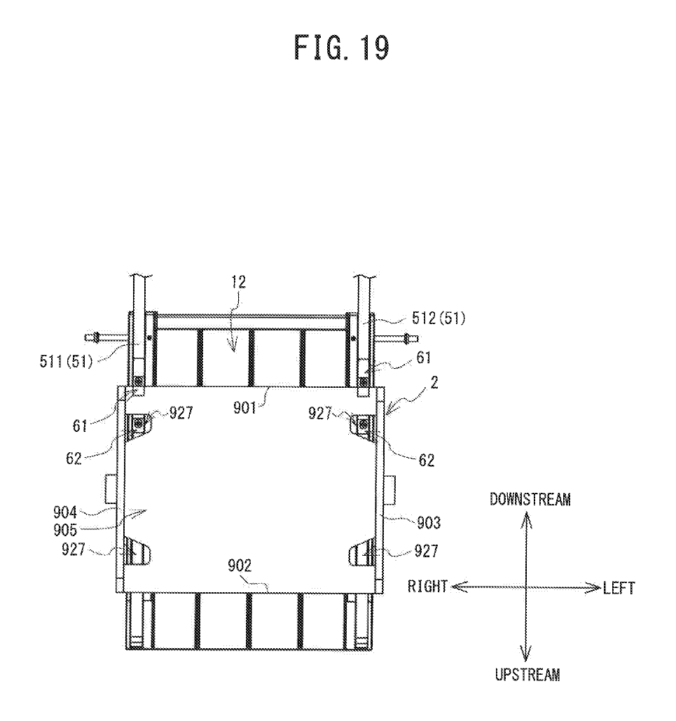

The base 2 will be explained with reference to FIG. 18 and FIG. 19. The base 2 is formed by folding a plate-shaped portion 90, which is a substantially rectangular-shaped plate, at folding portions 911 and 912. The base 2 is, for example, a corrugated cardboard base. FIG. 18 shows the base 2 in a state in which the plate-shaped portion 90 is bent in the same direction by the folding portions 911 and 912 each forming an acute angle of 90 degrees.

As shown in FIG. 18, the plate-shaped portion 90 has two sets of opposing sides, namely, a side 901 and a side 902, and a side 903 and a side 904. The sides 901 and 902 are sides that extend in the longer direction of the plate-shaped portion 90 and the sides 903 and 904 are sides that extend in the shorter direction of the plate-shaped portion 90. The folding portion 911 is coincident with a dividing line that is closest to the side 903, of three dividing lines that divide the plate-shaped portion 90 into four approximately equal sections in the longer direction. The folding portion 912 is coincident with the dividing line that is closest to the side 904, of the three dividing lines.

Hereinafter, the direction in which the shorter axis of the plate-shaped portion 90 extends will be called the conveyance direction, and the direction in which the longer axis of the plate-shaped portion 90 extends will be called the left-right direction. The side of the plate-shaped portion 90 on the side 901 will be called the downstream side, and the side on the side 902 will be called the upstream side, the side on the side 903 will be called the left side, and the side on the side 904 will be called the right side. The section of the plate-shaped portion 90 between the folding portions 911 and 912 will be called a first plate-shaped portion 905, and the section between the folding portion 911 and the side 903 and the section between the folding portion 912 and the side 904 will be called second plate-shaped portions 906 and 907, respectively.

The first plate-shaped portion 905 is orthogonal to each of the second plate-shaped portions 906 and 907 at the folding portions 911 and 912. Hereinafter, the direction that is orthogonal to the first plate-shaped portion 905 will be called the up-down direction. The side on which the sides 903 and 904 are arranged will be called the upper side and the opposite side will be called the lower side. The section of the lower surface of the first plate-shaped portion 905 that extends in the left-right direction along the side 901 is a first base end portion 928. The section of the lower surface of the first plate-shaped portion 905 that extends in the left-right direction along the side 902 is a second base end portion 929.

Through holes 937 that penetrate the second plate-shaped portions 906 and 907 in the left-right direction are formed in the center, in the conveyance direction, of the lower end portions of the second plate-shaped portions 906 and 907. Two holes 927 are formed in the left end of the first plate-shaped portion 905. The two holes 927 formed in the left end of the first plate-shaped portion 905 are formed on the upstream side and the downstream side with the hole 937 of the second plate-shaped portion 906 between them. Although not shown in the drawings, two holes 927 are also formed in the right end of the first plate-shaped portion 905. The two holes 927 formed in the right end of the first plate-shaped portion 905 are formed on the upstream side and the downstream side with the hole 937 of the second plate-shaped portion 907 between them.

As shown in FIG. 7 and FIG. 19, the base 2 is attached to the conveyance portion 60 that is arranged in the first position and is placed on the receiving tray 12. In FIG. 7, the base 2 is shown by virtual lines. The user moves the base 2 diagonally downward from the upstream side toward the downstream side into the space that is formed between the first extending portion 612 and the belt 51. The side 901 of the base 2 moves diagonally downward from the upstream side toward the downstream side, and enters and is fitted into the space formed between the first extending portion 612 and the belt 51.

The first extending portion 612 is in a state in which it covers the side 901 of the base 2 from above. The side 901 is arranged in the space formed between the first extending portion 612 and the belt 51, on both the right and left sides of the receiving tray 12. The second protruding portion 621 fits into the hole 927 on the downstream side. An aperture edge of the hole 927 that is on the downstream side enters into and is fitted into the space formed between the second extending portion 622 and the belt 51. The second extending portion 622 is in a state of covering, from above, the aperture edge of the hole 927 that is on the downstream side.

(11) Electrical Configuration of Packaging Device 1

The electrical configuration of the packaging device 1 will be explained with reference to FIG. 20. The packaging device 1 is provided with a CPU 201 that controls the entire packaging device 1. The CPU 201 is electrically connected to a ROM 202, a RAM 203, a tension detection sensor 204, an input portion 205, heaters 871, drive portions 211 to 216 and various sensors that will be explained later. The drive portions 211 to 216 are electrically connected to the first motor 221 to the sixth motor 226, respectively. The drive portions 211 to 216 are controllers that can drive the first motor 221 to the sixth motor 226 to which they are respectively connected. The CPU 201 drives the first motor 221 to the sixth motor 226 by controlling the drive portions 211 to 216.

Various processing programs that are executed by the CPU 201 and various tables, which will be explained later, are stored in the ROM 202. Temporary data is stored in the RAM 203. The tension detection sensor 204 is provided in the vicinity of the lower end of the lever 47, and detects which of the first state to the third state the lever 47 is in (refer to FIG. 10). Based on the state detected by the tension detection sensor 204, the CPU 201 can identify whether the current tension is “1.0,” “3.5” or “5.0” (the unit is kilogram-force).

A conveyance original point sensor 980 is provided on the inner side of the side plate portion 111, and detects a reflecting plate (not shown in the drawings) that is provided on the outer side surface of the belt 51. When the conveyance portions 60 are in the original position (namely, in the first position), the conveyance original point sensor 980 detects the reflecting plate of the belt 51 and is thus ON.

An area sensor 990 is formed of line sensors (refer to FIG. 4) that are aligned in the up-down direction on the upstream side end of the base transit portion 805. The area sensor 990 extends in the up-down direction from slightly above the conveyance portion 60 to the vicinity of the upper end of the base transit portion 805, and detects an object that passes through the upstream side end of the base transit portion 805. The area sensor 990 is provided above the conveyance portion 60 and thus the area sensor 990 does not detect the conveyance portion 60 even when the conveyance portion 60 enters into the base transit portion 805. In other words, among the objects that enter into the base transit portion 805, the area sensor 990 detects the object that is different to the conveyance portion 60 (the base 2 or a foreign object, for example). When the object that is different to the conveyance portion 60 enters into the base transit portion 805, the area sensor 990 detects the object and is thus ON.

A base attachment sensor 991 is provided directly below the receiving surface 12A of the receiving tray 12 and slightly to the upstream side of the first position of the conveyance portion 60 (refer to FIG. 4). The base attachment sensor 991 can detect an object that is disposed above the base attachment sensor 991. Therefore, when the base 2 is attached to the conveyance portion 60 in the first position (that is, when the base 2 is in the start position), the base attachment sensor 991 detects the base 2 and is thus ON.

A base center sensor 992 is provided substantially in the center, in the conveyance direction, of the base transit portion 805, and detects an object that is present on the movement path 104 (refer to FIG. 4). The base center sensor 992 is provided above the conveyance portion 60 and thus does not detect the conveyance portion 60 even if the conveyance portion 60 is present at the intersection position 105. In other words, among the objects that pass through the inside of the base transit portion 805, the base center sensor 992 detects the object that is different to the conveyance portion 60 (that is, the base 2 that is attached to the conveyance portion 60). When the base 2 passes through the base transit portion 805, the base center sensor 992 detects the base 2 and is thus ON. Further, when the base 2 is attached to the conveyance portion 60 that is in the fourth position (namely, when the base 2 is in the rear end bonding position), the base center sensor 992 detects the base 2 that is arranged at the intersection position 105 and is thus ON.

A base discharge sensor 993 is provided directly below the receiving surface 13A of the receiving tray 13 and slightly more to the upstream side than the second position of the conveyance portion 60 (refer to FIG. 5). The base discharge sensor 993 can detect an object that is disposed above the base discharge sensor 993. Thus, when the base 2 is attached to the conveyance portion 60 in the second position (namely, when the base 2 is in the end position), the base discharge sensor 993 detects the base 2 and is thus ON.

A heating portion original point sensor 994 is provided in the vicinity of the lower end of the movable range of the heating portion 86, and detects a reflecting plate (not shown in the drawings) that is provided on the heating portion 86. When the heating portion 86 is in the original position, the heating portion original point sensor 994 detects the reflecting plate of the heating portion 86 and is thus ON. A holding portion original point sensor 995 is provided in the vicinity of the lower end of the movable range of the holding portions 78 and detects a reflecting plate (not shown in the drawings) that is provided on the holding portions 78. When the holding portions 78 are in the original position, the holding portion original point sensor 995 detects the reflecting plate of the holding portions 78 and is thus ON. A holding portion pressure contact sensor 996 is provided in the vicinity of the upper end of the movable range of the holding portions 78 and detects the reflecting plate of the holding portions 78. When the holding portions 78 are in the pressure contact position, the holding portion pressure contact sensor 996 detects the reflecting plate of the holding portions 78 and is thus ON.

A support portion original position sensor 997 is provided in the vicinity of the upper end of the movable range of the support portions 34 and detects a reflecting plate (not shown in the drawings) that is provided on the support portions 34. When the support portions 34 are in the original position, the support portion original position sensor 997 detects the reflecting plate of the support portions 34 and is thus ON. A stopper original position sensor 998 is provided in the vicinity of the downstream side end of the movable range of the stopper 81 and detects a reflecting plate (not shown in the drawings) that is provided on the stopper 81. When the stopper is in the original position, the stopper original position sensor 998 detects the reflecting plate of the stopper 81 and is thus ON. A cutter original position sensor 999 is provided in the vicinity of the left end of the movable range of the cutter 77 and detects a reflecting plate (not shown in the drawings) that is provided on the cutter 77. When the cutter 77 is in the original position, the cutter original position sensor 999 detects the reflecting plate of the cutter 77 and is thus ON.

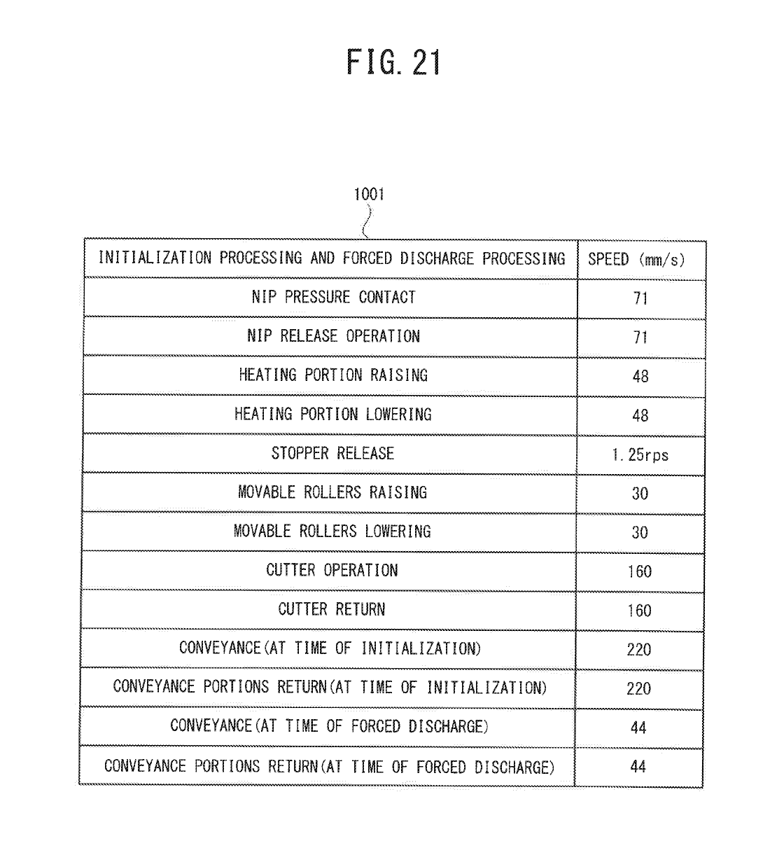

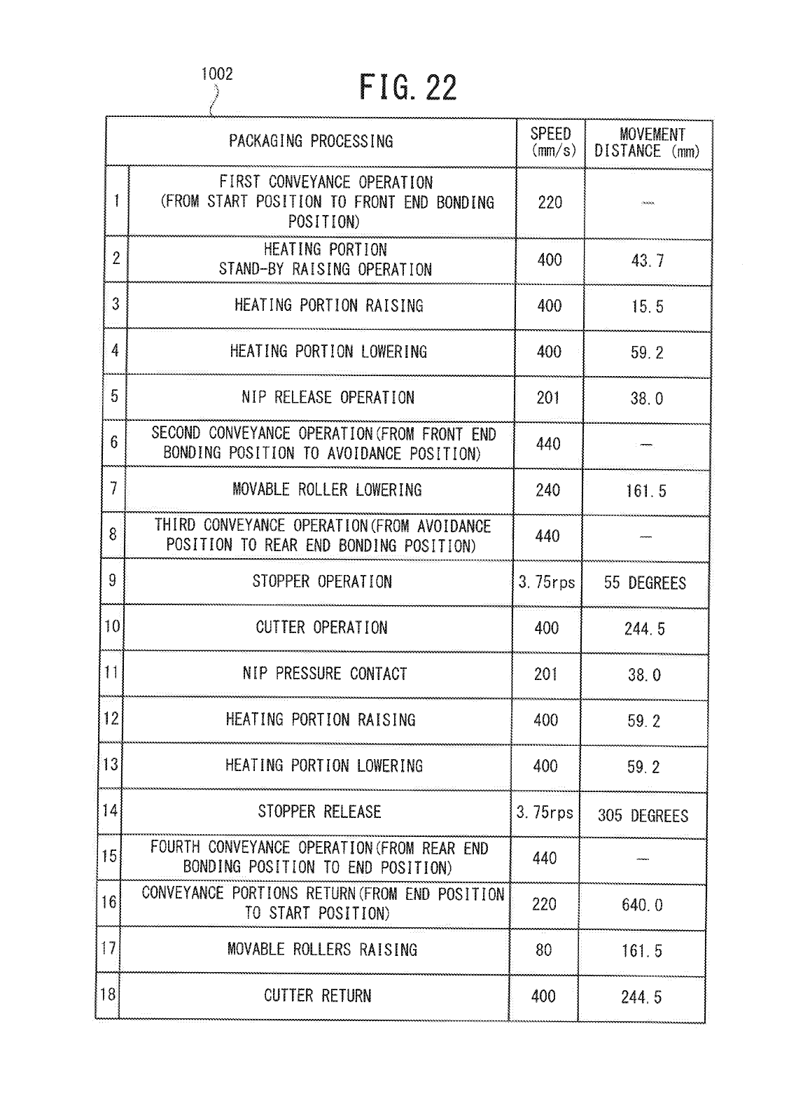

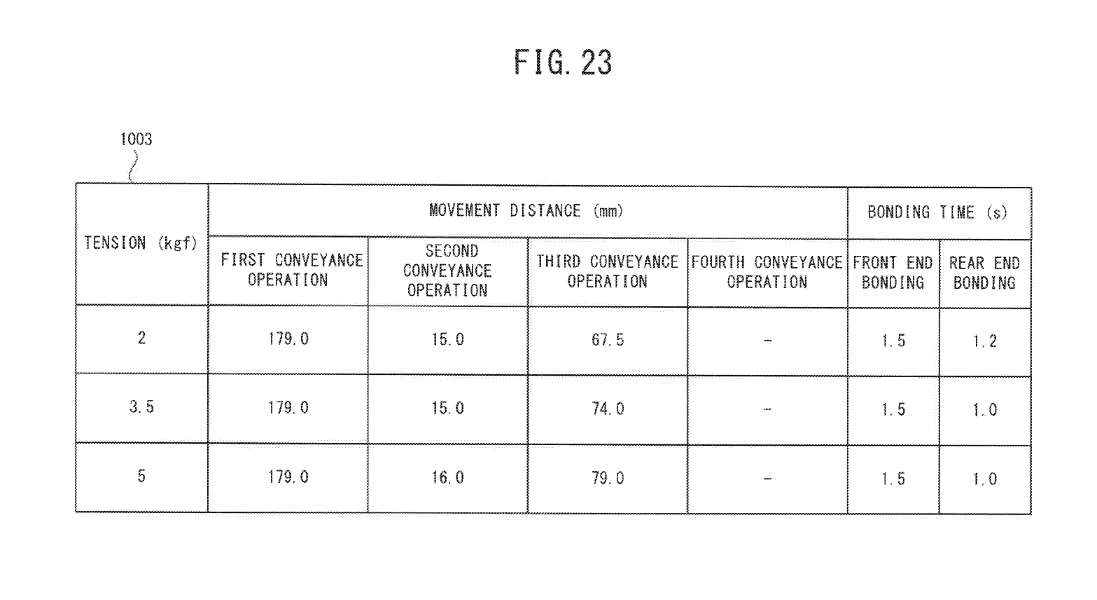

Tables that are stored in the ROM 202 will be explained. A first operation control table 1001 (refer to FIG. 21), a second operation control table 1002 (refer to FIG. 22), and a tension adjustment table 1003 (refer to FIG. 23) are stored in the ROM 202. In FIG. 21 to FIG. 23, the speed of each operation is expressed in seconds (mm/s) and a movement distance of each operation is expressed as millimeters (mm). However, the speed and the movement distance relating to the stopper 81 are expressed, respectively, by the revolutions per second of the cam 851 that causes the stopper 81 to move, and by the rotation angle of the cam 851 (in other words, the revolutions per second and the rotation angle of the fourth motor 224).

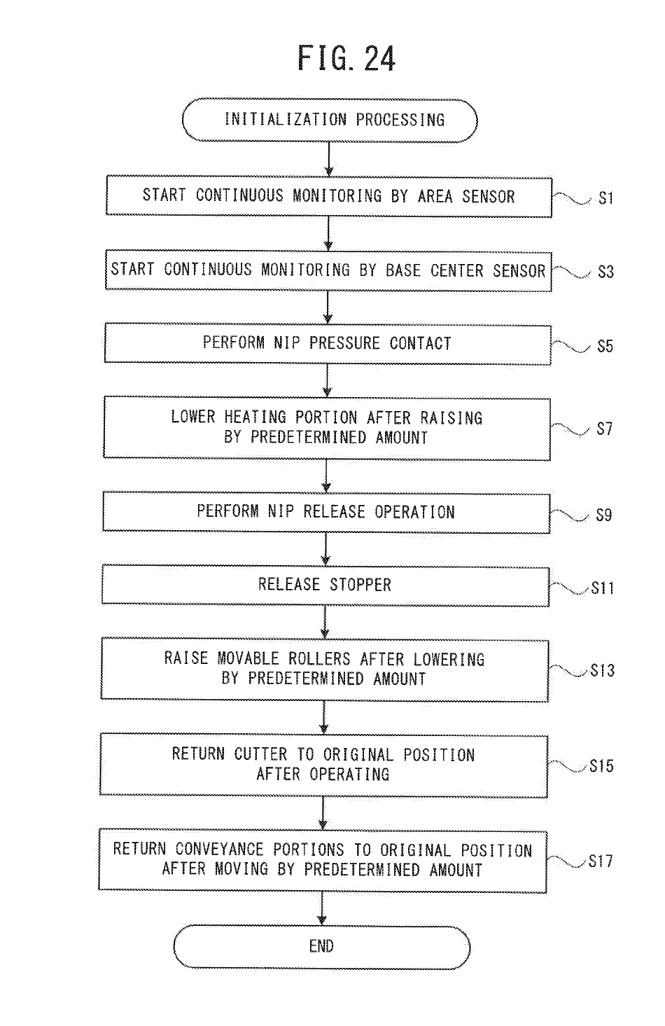

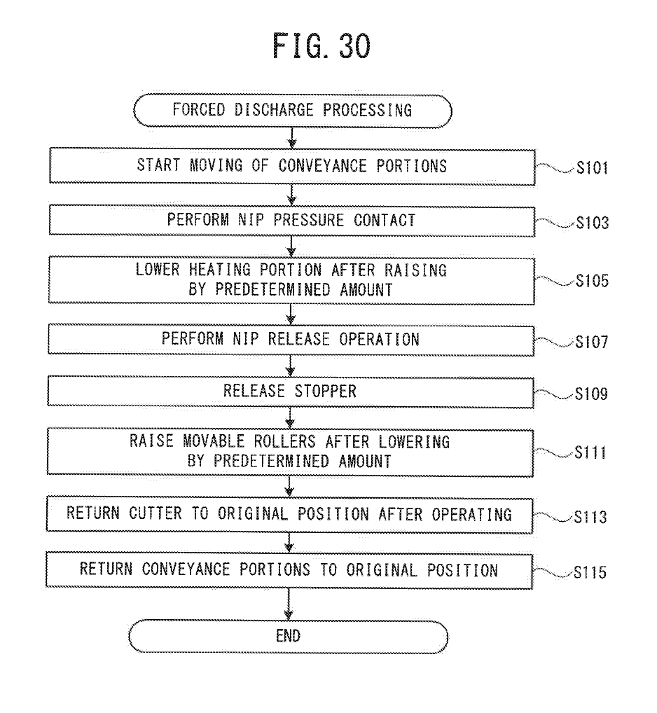

As shown in FIG. 21, the speeds of various operations performed by the packaging device 1 in initialization processing (refer to FIG. 24) and in forced discharge processing (refer to FIG. 30) that will be explained later are defined in the first operation control table 1001. When the CPU 201 performs the initialization processing and the forced discharge processing, each operation is performed at the speed defined in the first operation control table 1001. When the initialization processing and the forced discharge processing are started, the CPU 201 cannot ascertain the position of each of the members. Here, when performing the initialization processing and the forced discharge processing, the CPU 201 determines the positions of the members that are moved by each of the operations based on each of the above-described various sensors (refer to FIG. 20).

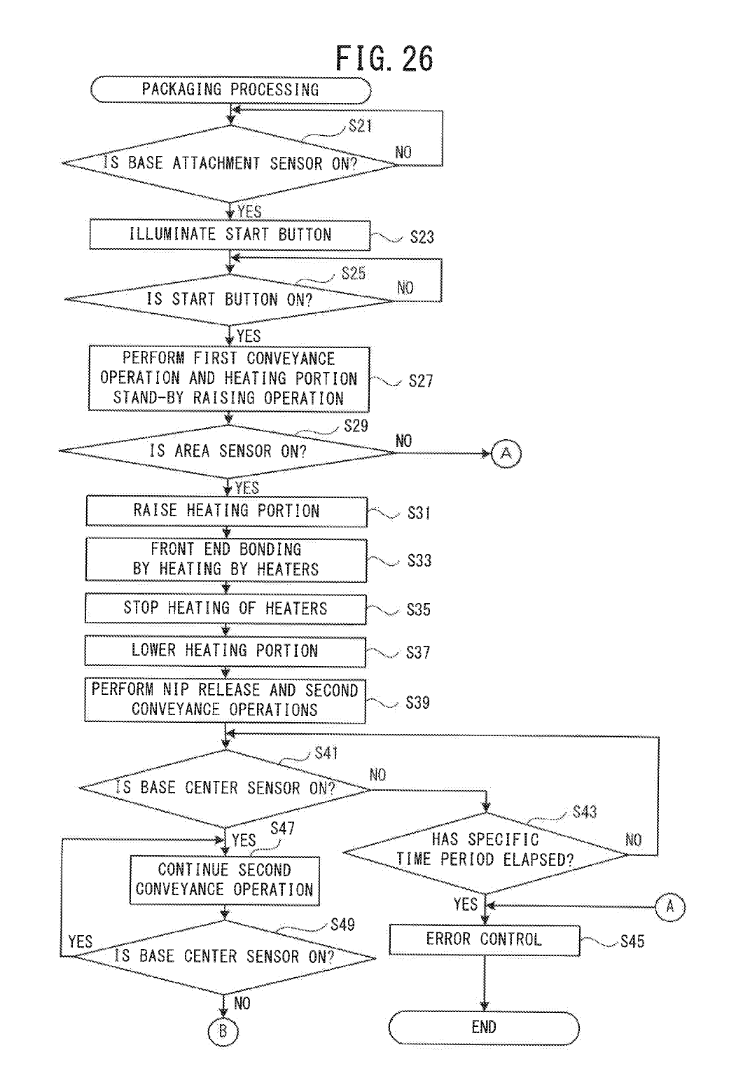

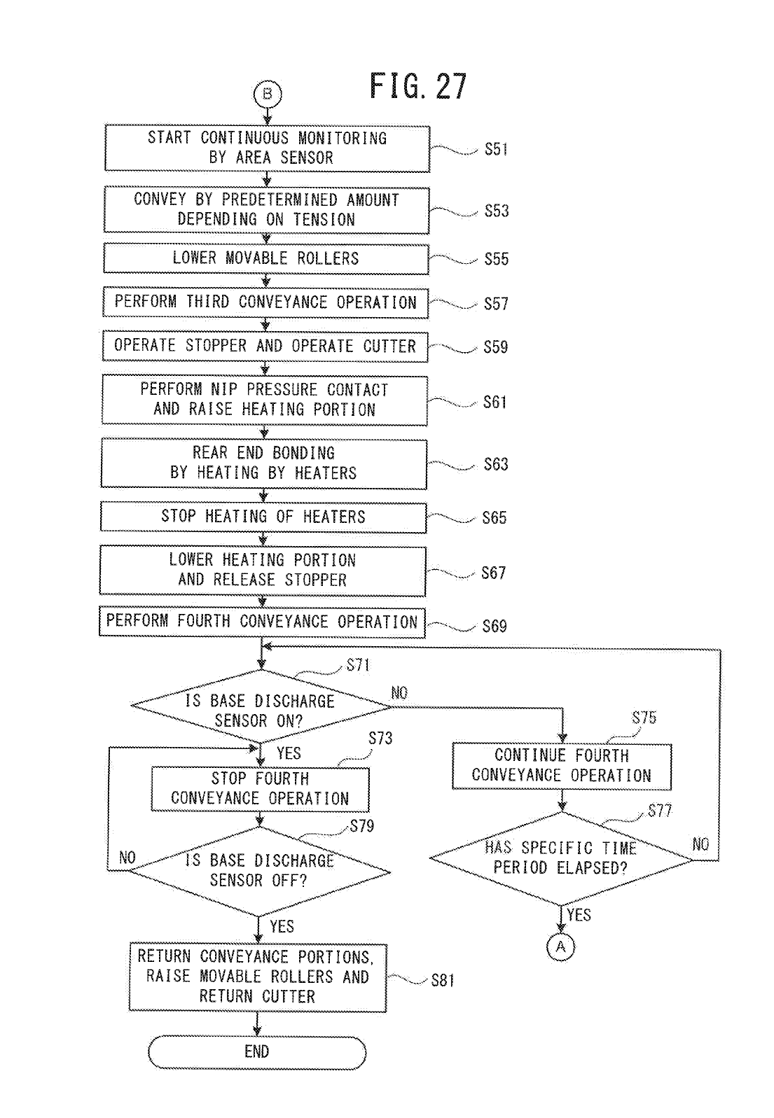

As shown in FIG. 22, the speed and the movement distance of each of the operations performed by the packaging device 1 in packaging processing (refer to FIG. 26 and FIG. 27) that will be explained later, are defined in the second operation control table 1002. When performing the packaging processing, the CPU 201 performs each of the operations at the speed and movement distance defined in the second operation control table 1002. As described later, when the packaging processing is started, as the packaging device 1 has been initialized, the CPU 201 can ascertain the position of each of the members. When performing the packaging processing, the CPU 201 determines the positions of the members that are moved by each of the operations based on the movement distances defined in the second operation control table 1002. However, the CPU 201 determines the movement distance of first to fourth conveyance operations that will be described later based on the following tension adjustment table 1003.

As shown in FIG. 23, the movement distance of the conveyance portion 60 and a bonding time of the film 24 are defined in the tension adjustment table 1003 in correspondence to the tension of the film 24 that is detected by the tension detection sensor 204. When performing the packaging processing, the CPU 201 performs the first to third conveyance operations (to be described later) using the movement distances defined in the tension adjustment table 1003, and performs front end bonding and rear end bonding (to be described later) based on bonding times defined in the tension adjustment table 1003. It should be noted that each of the movement distances of the second conveyance operation and the fourth conveyance operation changes depending on the length of the base 2 in the conveyance direction. In the present embodiment, in order to facilitate understanding, an example is explained in which a medium size base 2 (whose length in the conveyance direction is 400 mm, for example) is used.

(12) Various Processing of Packaging Device 1

Various processing performed by the CPU 201 will be explained with reference to FIG. 24 to FIG. 41. In the following explanation, the initialization processing that initializes a state of the packaging device 1, the packaging processing that covers the base 2 and the object 3 with the film 24, and the forced discharge processing that forcibly stops the packaging processing will be explained.

Before the user performs the operation to package the base 2 and the object 3 using the packaging device 1, the user swings the receiving trays 12 and 13 to make the receiving surfaces 12A and 13A horizontal and thus form the conveyance path 103 (refer to FIG. 1). When the user switches a power source of the packaging device 10N, the CPU 201 starts the initialization processing based on the programs stored in the ROM 202.

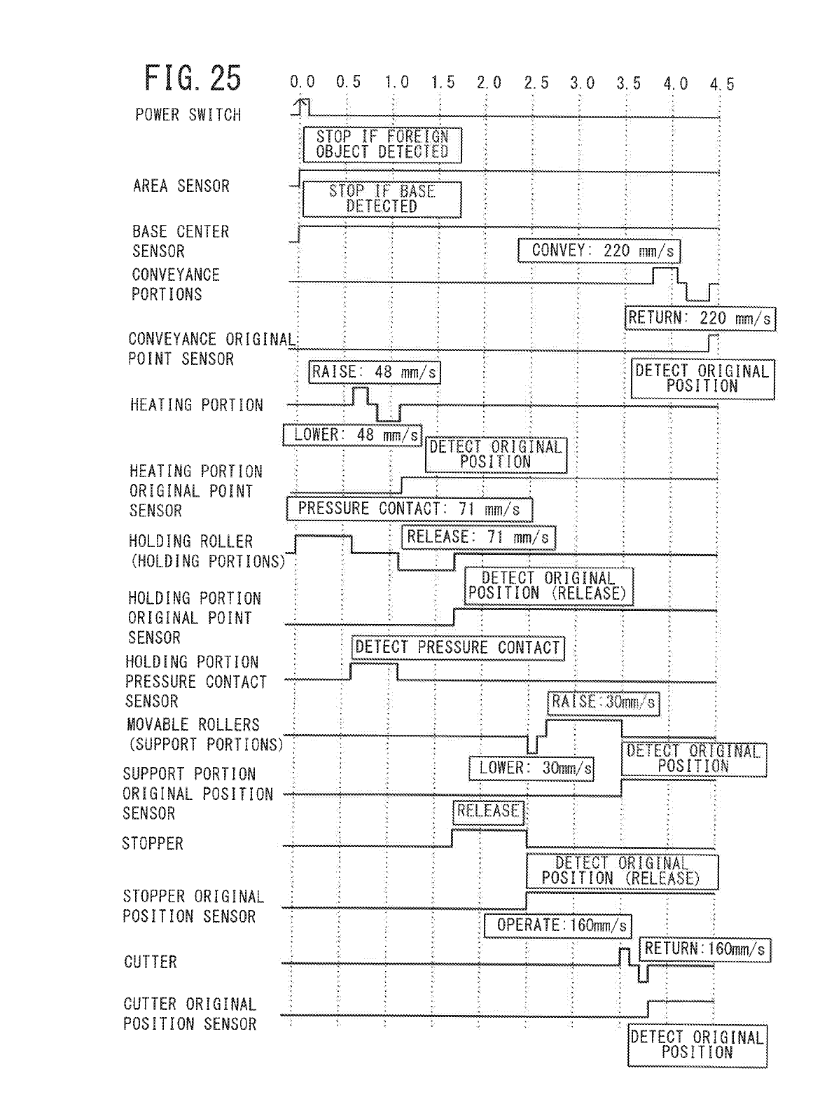

The initialization processing will be explained with reference to a flowchart shown in FIG. 24 and a timing chart shown in FIG. 25. The CPU 201 starts continuous monitoring by the area sensor 990 (step S1). When the continuous monitoring is started at step S1, the area sensor 990 continues to detect an object that enters into the base transit portion 805 from the upstream side until the initialization processing ends. After performing the processing at step S1, if the area sensor 990 comes ON, it is possible that the base 2 is attached to the conveyance portions 60, or a foreign object (the base 2 or the user's hand, for example) has entered into the base transit portion 805. In this case, there is a risk that the packaging device 1 cannot be correctly initialized and therefore, the CPU 201 stops the initialization processing and performs error control. The error control is a control in which various operations of the packaging device 1 (such as a movement operation of the conveyance portions 60 by the conveyance mechanism 50, a bonding operation of the film 24 by the heating portion 86, or a raising and lowering operation of the support portions 34) are forcibly stopped.

The CPU 201 starts continuous monitoring by the base center sensor 992 (step S3). When the continuous monitoring is started at step S3, the base center sensor 992 continues to detect the base 2 passing through the base transit portion 805 until the initialization processing ends. After performing the processing at step S3, if the base center sensor 992 comes ON, it is possible that the base 2 is attached to the conveyance portions 60. In this case, the CPU 201 stops the initialization processing and performs the error control in the same manner as described above.

The CPU 201 performs a nip pressure contact operation (step S5). The nip pressure contact operation is a control in which the holding roller 72 is caused to come close to the base guide roller 71. At step S5, the holding portions 78 are swung at a speed of 71 mm/s toward the upper end of the movable range of the holding portions 78 (refer to FIG. 21). When the holding portion pressure contact sensor 996 comes ON, the swinging of the holding portions 78 is stopped. In this manner, the holding portions 78 are moved to the pressure contact position.

The CPU 201 first raises the heating portion 86 by a predetermined amount and then lowers the heating portion 86 (step S7). At step S7, the heating portion 86 is raised at a speed of 48 mm/s by a predetermined amount (50 mm, for example) from its current position. Then, the heating portion 86 is lowered at a speed of 48 mm/s (refer to FIG. 2). When the heating portion original point sensor 994 comes ON, the lowering of the heating portion 86 is stopped. In this manner, the heating portion 86 is moved to the original position. Note that, when the heating portion 86 is in the original position at the start of the processing at step S7, when performing the processing at step S7, the heating portion 86 is raised by the predetermined amount and then returned to the original position.

The CPU 201 performs a nip release operation (step S9). The nip release operation is a control that causes the holding roller 72 to separate away from the base guide roller 71. At step S9, the holding portions 78 are swung at a speed of 71 mm/s toward the lower end of the movable range of the holding portions 78 (refer to FIG. 21). When the holding portion original point sensor 995 comes ON, the swinging of the holding portions 78 is stopped. In this manner, the holding portions 78 are moved to the original position.

The CPU 201 releases the stopper 81 (step S11). The release of the stopper 81 is a control in which the stopper 81 allows the guide roller 31 to rotate. At step S11, the cam 851 is caused to rotate at a rotation speed of 1.25 revolutions per second, and the stopper 81 is thus moved to the downstream side (refer to FIG. 21). When the stopper original position sensor 998 comes ON, the moving of the stopper 81 is stopped. In this manner, the stopper 81 is moved to the original position.

Next, the CPU 201 first lowers the movable rollers 30 by a predetermined amount and then raises them (step S13). At step S13, the support portions 34 that support the movable rollers 30 are lowered at a speed of 30 mm/s by a predetermined amount (50 mm, for example) from their current position. Next, the support portions 34 are raised at a speed of 30 mm/s (refer to FIG. 21). When the support portion original position sensor 997 comes ON, the raising of the support portions 34 is stopped. In this manner, the support portions 34 are moved to the original position and the guide roller 31 is moved to the upper guide position. Note that, when the support portions 34 are in the original position at the start of the processing at step S13, when performing the processing at step S13, the support portions 34 are lowered by the predetermined amount and then returned to the original position.

Next, the CPU 201 operates the cutter 77 and then returns the cutter 77 to the initial position (step S15). At step S15, the cutter 77 is moved to the right at a speed of 160 mm/s until it reaches the right end of the movable range of the cutter 77. Next, the cutter 77 is moved to the left at a speed of 160 mm/s (refer to FIG. 21). When the cutter original position sensor 999 comes ON, the moving of the cutter 77 is stopped. In this manner, the cutter 77 is moved to the original position.

Finally, the CPU 201 moves the conveyance portions 60 by a predetermined amount and then returns them to the original position (that is, to the first position) (step S17). At step S17, the conveyance portions 60 are conveyed at a speed of 220 mm/s to the downstream side from the current position by a predetermined amount (50 mm, for example). Next, the conveyance portions 60 are moved to the upstream side at a speed of 220 mm/s. When the conveyance original point sensor 980 comes ON, the moving of the conveyance portions 60 is stopped. In this manner, the conveyance portions 60 are moved to the first position.

The packaging device 1 is initialized by the above-described processing. After that, the user manually pulls out the film 24 discharged from the film cassette 21 downward and past the upstream side of the second auxiliary roller 33. By coming into contact with the upstream side of the second auxiliary roller 33, the film 24 is guided slightly to the upstream side. The user pulls the leading end of the film 24 that has been pulled downward to the lower side of the conveyance path 103, and arranges the leading end of the film 24 on the downstream side of the base guide roller 71 (refer to FIG. 32).

The user performs an input operation (a preparation complete instruction) via the input portion 205 to notify the packaging device 1 that the preparation of the film 24 is completed. When the preparation complete instruction is input, the CPU 201 performs the nip pressure contact operation in a similar manner to step S5. In this way, as shown in FIG. 32, the leading end of the film 24 pulled out from the film cassette 21 is clamped on both sides, in the conveyance direction, by the base guide roller 71 and the holding roller 72. The film 24 and the conveyance path 103 intersect in the vicinity of the leading end of the film 24.

By moving the lever 47 (refer to FIG. 10) to one of the first to third states depending on the type of the object 3 to be packaged, the user sets the tension of the film 24. For example, when a strong tension is not suitable to be applied to the object 3, the user moves the lever 47 to the first state and thus sets the tension exerted on the film 24 to its smallest value. By the torque applied to the film roll 22 by the torque adjustment mechanism 40, the tension exerted on the film 24 accords with the state of the lever 47. The film 24 extends straight up and down between the upstream side of the second auxiliary roller 33 and the section that is clamped by the base guide roller 71 and the holding roller 72.

The user attaches the base 2 to the conveyance portions 60 that are arranged in the first position, and places the base 2 on the receiving tray 12. At that time, the side 901 of the base 2 is arranged on the downstream side, and the side 902 is arranged on the upstream side. The user places the object 3 on the first plate-shaped portion 905 of the base 2 that is placed on the receiving tray 12. The CPU 201 starts the packaging processing based on the programs stored in the ROM 202.

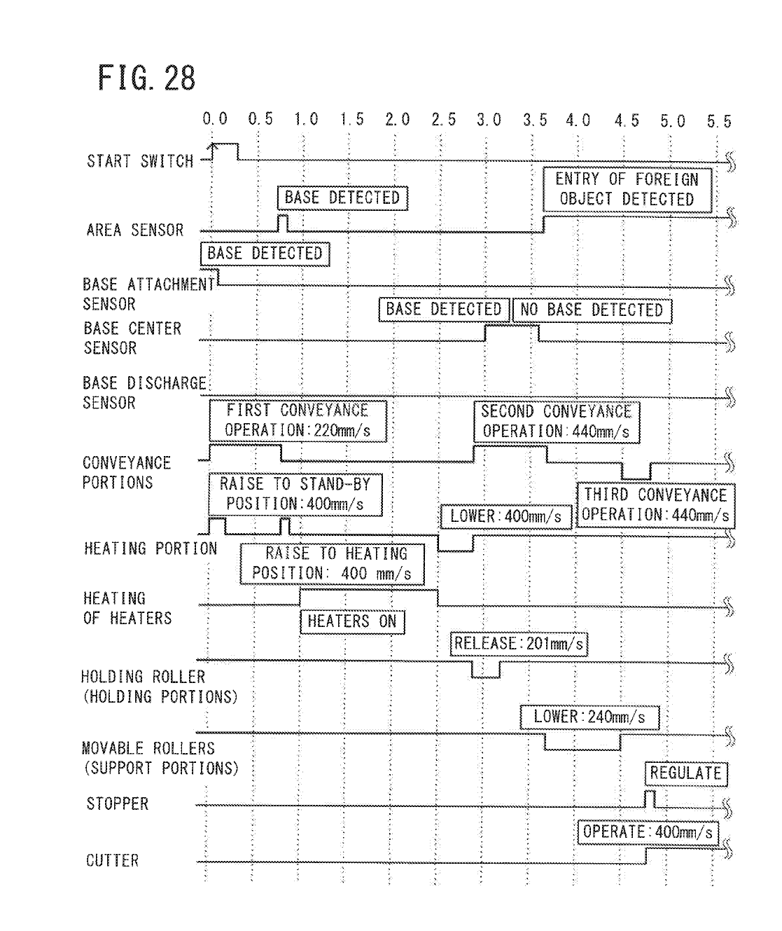

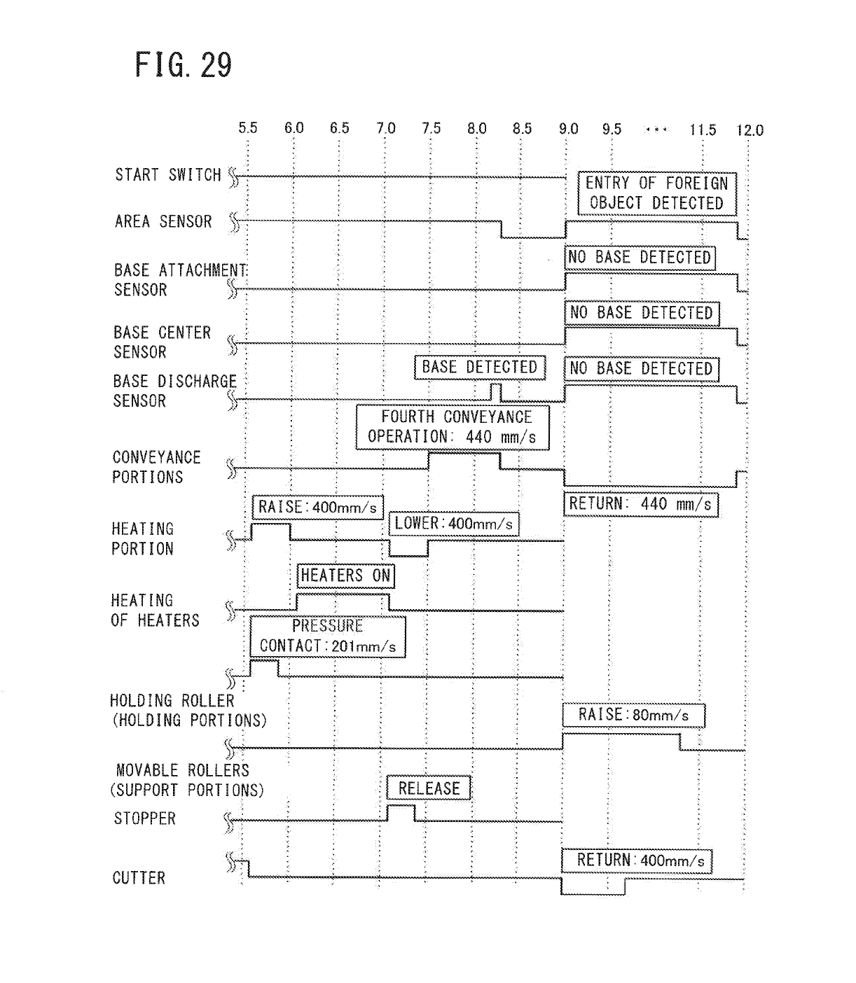

The packaging processing will be explained with reference to flowcharts shown in FIG. 26 and FIG. 27 and timing charts shown in FIGS. 28 and 29. In the following explanation, state-transition diagrams shown in FIG. 32 to FIG. 41 will be referred to as appropriate. FIG. 32 to FIG. 41 are diagrams of the left side of the packaging device 1 as seen roughly from the center in the left-right direction, and only the configuration necessary to explain each of operating states is illustrated.

The CPU 201 determines whether the base attachment sensor 991 is ON (step S21). When the user has attached the base 2 to the conveyance portions 60 as described above, the base attachment sensor 991 detects the base 2 in the start position and is thus ON. When the base attachment sensor 991 is ON (yes at step S21), the CPU 201 illuminates a start button that is not shown in the drawings (step S23). When the base attachment sensor 991 is OFF (no at step S21), the CPU 201 repeatedly performs the processing at step S21 and thus waits for the base 2 to be attached to the conveyance portions 60.

After the processing at step S23 is performed, the CPU 201 determines whether the start button is ON (step S25). The start button is ON when the user has depressed the start button. When the start button is OFF (no at step S25), the CPU 201 repeats the processing at step S25 and thus waits for the start button to be depressed. When the start button is ON (yes at step S25), a start command is input into the CPU 201. When the start command has been input, the CPU 201 concurrently performs the first conveyance operation and a heating portion stand-by raising operation (step S27). In the present embodiment, the first conveyance operation and the heating portion stand-by raising operation are started simultaneously. However, as long as execution time periods of each of the operations at least partially overlap with each other, one of the first conveyance operation and the heating portion stand-by raising operation may be started in advance of the other.

The first conveyance operation is a control that conveys the base 2 to the downstream side from the start position to the front end bonding position, in a state in which the guide roller 31 is in the upper guide position and the film 24 that is guided from the guide roller 31 to the heating portion 86 intersects the conveyance path 103. At step S27, the conveyance portions 60 are moved to the downstream side from the first position at a speed of 220 mm/s (refer to FIG. 22). Based on a number of revolutions of the second motor 222, when the conveyance portions 60 have been moved by the movement distance set in the tension adjustment table 1003 (refer to FIG. 23), the moving of the conveyance portions 60 is stopped. In the present embodiment, the movement distance of the first conveyance operation is 179.0 mm, irrespective of the tension of the film 24. In this way, the first conveyance operation ends, the conveyance portions 60 move to the third position and the base 2 is moved from the start position to the front end bonding position.

When the first conveyance operation is performed, the state of the packaging device 1 changes in the following manner. As shown in FIG. 33, the downstream side end (the side 901) of the base 2 gradually approaches the film 24 that is extending such that it intersects with the conveyance path 103. The base 2 that is moving to the downstream side enters into the base transit portion 805. The side 901 of the base 2 comes into contact with the film 24, and thereafter passes over the holding roller 72. The side 901 of the base 2 approaches the intersection position 105 while pushing the film 24 to the downstream side. The base 2 moves further to the downstream side and the side 901 of the base 2 passes above the heating portion 86. At that time, the leading end of the film 24 that is held by the base guide roller 71 and the holding roller 72 reaches around to the lower surface of the first plate-shaped portion 905 of the base 2.

The heating portion stand-by raising operation is a control that raises the heating portion 86 from the initial position to a stand-by position. At step S27, the heating portion 86 is raised from the original position at a speed of 400 mm/s. Based on a number of revolutions of the third motor 223, when the heating portion 86 has been moved by 43.7 mm, the raising of the heating portion 86 is stopped (refer to FIG. 22). In this manner, as shown in FIG. 33, the heating portion 86 is moved from the original position to the stand-by position, and the distance from the heating portion 86 to the conveyance path 103 becomes smaller. As the execution time period of the heating portion stand-by raising operation is shorter than the execution time period of the first conveyance operation, the heating portion stand-by raising operation is completed before the first conveyance operation is completed.

After performing the processing at step S27, the CPU 201 determines whether the area sensor 990 is ON (step S29). As shown in FIG. 33, when the base 2 has been conveyed to the front end bonding position by the first conveyance operation, the area sensor 990 detects the base 2 and is thus ON (yes at step S29). In this case, the base 2 has been conveyed into the interior of the base transit portion 805, and the CPU 201 further raises the heating portion 86 (step S31). At step S31, the heating portion 86 is raised from the stand-by position at a speed of 400 mm/s. Based on a number of revolutions of the third motor 223, when the heating portion 86 has been moved by 15.5 mm, the raising of the heating portion 86 is stopped (refer to FIG. 22). In this way, as shown in FIG. 34, the heating portion 86 is moved from the stand-by position to the heating position. The film 24 is in a state of being clamped between the top surface of each of the heating units 87 (refer to FIG. 16) of the heating portion 86 and the first base end portion 928 (refer to FIG. 18) of the base 2.

The CPU 201 heats the heaters 871 of the heating portion 86 and performs the front end bonding (step S33). The front end bonding is a control that adheres, to the first base end portion 928, the leading end of the film 24 that has been heated and melted by the heaters 871. The CPU 201 stops the heating of the heaters 871 (step S35) after a bonding time period that is set in the tension adjustment table 1003 (refer to FIG. 23) has elapsed from a start of the heating of the heaters 871. The bonding time is a time period that is necessary for the heaters 871 to heat the film 24 to its melting point. In the present embodiment, the bonding time of the front end bonding is 1.5 seconds, irrespective of the tension of the film 24.

The CPU 201 lowers the heating portion 86 (step S37). At step S37, the heating portion 86 is lowered from the heating position at a speed of 400 mm/s. Based on a number of revolutions of the third motor 223, when the heating portion 86 has been lowered by 59.2 mm, the lowering of the heating portion 86 is stopped (refer to FIG. 22). In this manner, as shown in FIG. 35, the heating portion 86 is moved from the heating position to the original position.

The CPU 201 concurrently performs the nip release operation and the second conveyance operation (step S39). In the present embodiment, the nip release operation and the second conveyance operation are started simultaneously. However, as long as execution time periods of each of the operations at least partially overlap with each other, the nip release operation may be started in advance of the second conveyance operation. At step S39, the holding portions 78 are swung toward the lower side from the pressure contact position at a speed of 201 mm/s. Based on a number of revolutions of the sixth motor 226, when the holding portions 78 are moved by 38.0 mm, the swinging of the holding portions 78 is stopped (refer to FIG. 22). In this manner, as shown in FIG. 35, the holding portions 78 are moved from the pressure contact position to the original position. The base guide roller 71 and the holding roller 72 release the leading end of the film 24 that was clamped between them.

The second conveyance operation is a control that conveys the base 2 toward the downstream side from the front end bonding position to the avoidance position. At step S39, the conveyance portions 60 are conveyed toward the downstream side from the third position at a speed of 440 mm/s (refer to FIG. 22). When the second conveyance operation is performed, the state of the packaging device 1 changes in the following manner. As shown in FIG. 35, the base 2 is conveyed from the front end bonding position through the interior of the base transit portion 805. At that time, the base 2 moves toward the downstream side while the leading end of the film 24 is in a state of being bonded to the first base end portion 928. The side 901 of the base 2 moves toward the downstream side via the intersection position 105.

Tension is exerted on the film 24 by the torque applied to the film roll 22 from the torque adjustment mechanism 40. Thus, the film 24 is pushed against the side 901 of the base 2 and against the downstream side end of the object 3, and bends at the contact portion with the side 901 and the contact portion with the object 3. In accordance with the movement of the base 2, the film 24 is pulled out gradually from the film roll 22. The film 24 is closely adhered to the base 2 and the object 3 in a position in which the film 24 covers the downstream side of the first plate-shaped portion 905 and the object 3.

The base 2 continues to be conveyed toward the downstream side, and, as a result, the upstream side end (the side 902) of the base 2 passes over the base guide roller 71. The side 902 of the base 2 passes through the intersection position 105 and moves toward the downstream side. The film 24 that extends from the film roll 22 extends toward the downstream side via the first auxiliary roller 32 and reaches the side 901 of the base 2 and the downstream side of the object 3. The guide roller 31 is arranged above the film 24 that extends between the first auxiliary roller 32 and the base 2 and the object 3.

The CPU 201 determines whether the base center sensor 992 is ON (step S41). When the base 2 is attached to the conveyance portions 60, in the course of the base 2 being conveyed from the front end bonding position to the avoidance position, the base center sensor 992 detects the base 2 and is thus ON (yes at step S41). Meanwhile, when the base center sensor 992 does not detect the base 2 (no at step S41), the CPU 201 determines whether a specific time period has elapsed since the start of the processing at step S39 (step S43). When the specific time period has not elapsed since the start of the processing at step S39 (no at step S43), the CPU 201 repeats the processing at step S41 and step S43, and thus waits for the base center sensor 992 to detect the base 2 within the specific time period.

When the specific time period has elapsed from the start of the processing at step S39 (yes at step S43), this means that the base 2 is not attached to the conveyance portions 60 or that the base 2 has not been appropriately conveyed through the interior of the base transit portion 805, and thus the CPU 201 performs the error control (step S45). Note that when the area sensor 990 does not detect the base 2 at step S29 (yes at step S29), this means that the base 2 has not been appropriately conveyed into the interior of the base transit portion 805 and the CPU 201 performs the error control (step S45). After the processing at step S45 is performed, the packaging processing ends.

When the base center sensor 992 is ON (yes at step S41), the base 2 has not reached the avoidance position and the CPU 201 continues the second conveyance operation (step S47). Further, the CPU 201 determines whether the base center sensor 992 is ON (step S49). When the base center sensor 992 is ON (yes at step S49), the CPU 201 repeats the processing at step S47 and step S49 until the base 2 is no longer detected by the base center sensor 992. Meanwhile, when the entire base 2 has moved further to the downstream side than the intersection position 105, the base center sensor 992 switches to OFF (no at step S49). In this case, similarly to the processing at step S1, the CPU 201 starts the continuous monitoring by the area sensor 990 (step S51).

When the continuous monitoring is started at step S51, the area sensor 990 continues to detect the object that enters the base transit portion 805 from the upstream side until the packaging processing ends. After the processing at step S51 is performed, if the area sensor 990 is ON, there is a possibility that there is a foreign object (the user's hand, for example) in the base transit portion 805. In this case, the CPU 201 stops the packaging processing and performs the error control.

The CPU 201 conveys the conveyance portions 60 by a predetermined amount toward the downstream side, depending on the tension of the film 24 (step S53). At step S53, even after the base center sensor 992 has switched to OFF, the conveyance portions 60 continue to be conveyed toward the downstream side at a speed of 440 mm/s. When the conveyance portions 60 have been moved by the movement distance set in the tension adjustment table 1003 (refer to FIG. 23) from the point in time at which the base center sensor 992 switches to OFF (no at step S49), the moving of the conveyance portions 60 is stopped. The second conveyance operation is ended in this manner, the conveyance portions 60 move to the fifth position and the base 2 is moved from the front end bonding position to the avoidance position.

The greater the tension of the film 24, the larger the strength with which the film 24 is pressed against the base 2 and the object 3 by the second conveyance operation. Thus, when the tension of the film 24 is greater, the movement distance of the base 2 when the second motor 222 has rotated the predetermined amount is smaller than the intended movement distance. In the present embodiment, the greater the tension of the film 24 set by the user, the larger the movement distance of the second conveyance operation (refer to FIG. 23). Specifically, when the tension of the film 24 is 2.0 kgf or 3.5 kgf, the movement distance of the second conveyance operation is 15.0 mm, while the movement distance of the second conveyance operation is 16.0 mm when the tension of the film 24 is 5.0 kgf. In this manner, irrespective of the tension of the film 24, the movement distance of the base 2 in the second conveyance operation remains constant.

The CPU 201 lowers the movable rollers 30 (step S55). At step S55, the support portions 34 that support the movable rollers 30 are lowered from the upper guide position at a speed of 240 mm/s. Based on a number of revolutions of the first motor 221, when the support portions 34 have been lowered by 161.5 mm, the lowering of the support portions 34 is stopped (refer to FIG. 22). In this manner, as shown in FIG. 36, the support portions 34 are moved from the original position to the lowered position. At this time, the guide roller 31 descends along the movement path 104 and is moved from the upper guide position to the lower guide position.

The guide roller 31 is in a state of being in contact, from below, with the conveyance path 103. The film 24 is arranged in a position in which it covers the upstream side of the base 2 and the object 3. The film 24 extends from the side 902 of the base 2 toward the guide roller 31, extends toward the first auxiliary roller 32 via the guide roller 31, and then reaches the film roll 22 via the first auxiliary roller 32 and the second auxiliary roller 33. Of the film 24, the section that extends between the guide roller 31 and the first auxiliary roller 32 extends substantially horizontally and is positioned lower than the upper edge of the blade portion 771. At this time, as the cutter 77 has moved to the original position, there is no contact between the film 24 and the blade portion 771.

The CPU 201 performs the third conveyance operation (step S57). The third conveyance operation is a control in which the base 2 is conveyed toward the upstream side from the avoidance position to the rear end bonding position in a state in which the film 24 that extends from the guide roller 31 toward the object 3 intersects the conveyance path 103. At step S57, the conveyance portions 60 are moved toward the upstream side from the fifth position at a speed of 440 mm/s (refer to FIG. 22). Based on a number of revolutions of the second motor 222, when the conveyance portions 60 are moved by the movement distance set in the tension adjustment table 1003 (refer to FIG. 23), the moving of the conveyance portions 60 is stopped. In this manner, the third conveyance operation ends, the conveyance portions 60 move to the fourth position and the base 2 is moved from the avoidance position to the rear end bonding position.

When performing the third conveyance operation, the state of the packaging device 1 changes in the following manner. As shown in FIG. 37, the side 902 of the base 2 passes over the heating portion 86 after passing through the intersection position 105. At that time, the guide roller 31 is in contact, from the lower side, with the lower surface of the first plate-shaped portion 905 of the base 2, and the guide roller 31 moves relatively toward the downstream side from the side 902. The film 24 is clamped between the first plate-shaped portion 905 and the guide roller 31. The film 24 extends along the lower surface of the first plate-shaped portion 905 from the side 902 toward the guide roller 31, extends toward the first auxiliary roller 32 via the guide roller 31, and then reaches the film roll 22 via the first auxiliary roller 32 and the second auxiliary roller 33. The first auxiliary roller 32 and the second auxiliary roller 33 support the film 24 that extends from the guide roller 31 to the film roll 22 such that the film 24 does not come into contact with the base 2.

Specifically, the film 24 is pulled around from the downstream side end to the upstream side end of the base 2 such that the film 24 covers the object 3 from above. In this state, when the third conveyance operation is performed, the base 2 is conveyed to the upstream side in resistance to the tension of the film 24. The greater the tension of the film 24, the larger the repulsive force of the film 24 that is being pushed by the base 2 and the object 3 as a result of the third conveyance operation. Thus, when the tension of the film 24 is greater, the movement distance of the base 2 when the second motor 222 has rotated the predetermined amount is smaller than the intended movement distance.

In the present embodiment, the greater the tension of the film 24 set by the user, the larger the movement distance of the third conveyance operation (refer to FIG. 23). Specifically, when the tension of the film 24 is 2.0 kgf, the movement distance of the third conveyance operation is 67.5 mm. When the tension of the film 24 is 3.5 kgf, the movement distance of the third conveyance operation is 74.0 mm. When the tension of the film 24 is 5.0 kgf, the movement distance of the third conveyance operation is 79.0 mm. In this manner, irrespective of the tension of the film 24, the movement distance of the base 2 in the third conveyance operation remains constant.

The CPU 201 concurrently operates the stopper 81 and operates the cutter 77 (step S59). At step S59, the movement of the cutter 77 is started while the stopper 81 is moved from the original position to the regulating position, and the film 24 is cut away by the cutter 77 after the stopper 81 has been moved to the regulating position. The stopper 81 and the cutting portion 77 are controlled in the following manner,

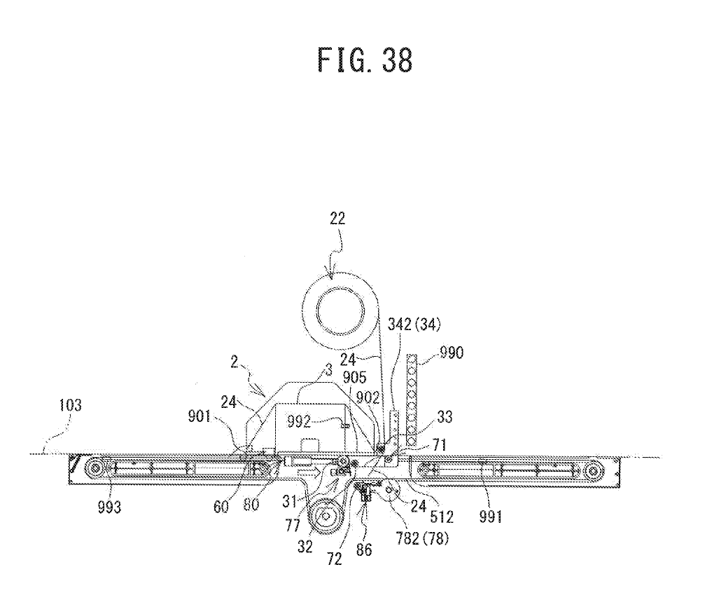

The operation of the stopper 81 is a control in which the rotation of the guide roller 31 is regulated by the stopper 81. At step S59, the cam 851 is caused to rotate at a rotation speed of 3.75 revolutions per second, and the stopper 81 is thus moved from the original position to the upstream side. Based on a number of revolutions of the fourth motor 224, when the cam 851 has been rotated by 55 degrees, the moving of the stopper 81 is stopped (refer to FIG. 22). In this manner, as shown in FIG. 38, the stopper 81 is moved from the original position to the regulating position. The rotation of the guide roller 31 is inhibited, and the film 24 is clamped between the guide roller 31 and the rubber strip 811 of the stopper 81.

At step S59, the cutter 77 is moved to the right from the original position at a speed of 400 mm/s. Based on a number of revolutions of the fifth motor 225, when the cutter 77 has been moved 244.5 mm, the moving of the cutter 77 is stopped (refer to FIG. 22). In this manner, the cutter 77 is moved from the original position to the right end of the movable range of the cutter 77. Of the film 24 that is held by the guide roller 31 and the stopper 81, the section of the film 24 between the guide roller 31 and the first auxiliary roller 32 is cut by the blade portion 771. The cutter 77 cuts away the section of the film 24 that covers the first plate-shaped portion 905 of the base 2 and the object 3 from the section of the film 24 that is wound on the film roll 22. As shown in FIG. 38, after the film 24 is cut, the cut end of the film 24 that extends from the film roll 22 hangs straight down to the side below the base guide roller 71.

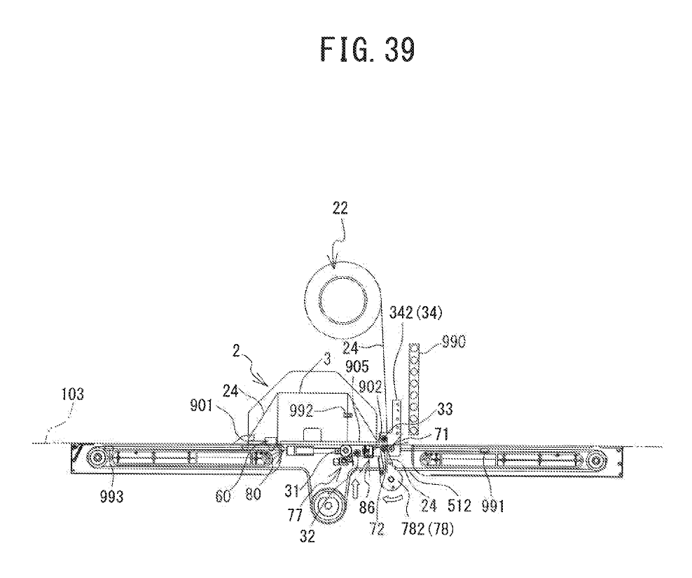

The CPU 201 concurrently performs the nip pressure contact operation and the raising of the heating portion 86 (step S61). In the present embodiment, the nip pressure contact operation and the raising of the heating portion 8 are started simultaneously. However, as long as execution time periods of each of the operations at least partially overlap with each other, the nip pressure contact operation may be started in advance of the raising of the heating portion 86. At step S61, the holding portions 78 are swung from the original position toward the upper end of the movable range at a speed of 201 mm/s. Based on a number of revolutions of the sixth motor 226, when the holding portions 78 have been moved 38.0 mm, the swinging of the holding portions 78 is stopped (refer to FIG. 22). In this manner, as shown in FIG. 39, the holding portions 78 are moved from the original position to the pressure contact position. The end of the film 24 that has been cut by the cutter 77 is clamped by the base guide roller 71 and the holding roller 72.

At step S61, the heating portion 86 is raised from the initial position at a speed of 400 mm/s. Based on a number of revolutions of the third motor 223, when the heating portion 86 has been moved 59.2 mm, the raising of the heating portion 86 is stopped (refer to FIG. 22). In this manner, as shown in FIG. 39, the heating portion 86 is moved from the initial position to the heating position. The film 24 is clamped between the top surfaces of the heating units 87 (refer to FIG. 36) of the heating portion 86 and the second base end portion 929 (refer to FIG. 18) of the base 2.

The CPU 201 heats the heaters 871 of the heating portion 86 and performs the rear end bonding (step S63). The rear end bonding is a control in which the leading end of the film 24 that is heated and melted by the heaters 871 is bonded to the second base end portion 929. The CPU 201 stops the heating of the heaters 871 (step S65) after a bonding time period that is set in the tension adjustment table 1003 (refer to FIG. 23) has elapsed from a start of the heating of the heaters 871. In this manner, as shown in FIG. 39, the film 24 that has been cut away from the film roll 22 covers the base 2 and the object 3.

In the present embodiment, the greater the tension of the film 24 set by the user, the shorter the bonding time period of the rear end bonding (refer to FIG. 23). Specifically, when the tension of the film 24 is 2.0 kgf, the bonding time period of the rear end bonding is 1.2 seconds. When the tension of the film 24 is 3.5 kgf or 5.0 kgf, the bonding time period of the rear end bonding is 1.0 seconds. When the tension of the film 24 is large, the film 24 that wraps the base 2 and the object 3 adheres strongly to the second base end portion 929 and thus the film 24 can be fully bonded in a relatively short bonding time period. Thus, by changing the bonding time period depending on the tension of the film 24, it is possible to bond the film 24 to the base 2 at a constant strength. When the tension of the film 24 is large, the film 24 can be bonded to the base 2 in a short time period.

The CPU 201 concurrently performs the lowering of the heating portion 86 and the release of the stopper 81 (step S67). In the present embodiment, the lowering of the heating portion 86 and the release of the stopper 81 are started simultaneously. However, as long as execution time periods of each of the operations at least partially overlap with each other, one of the lowering of the heating portion 86 and the release of the stopper 81 may be started in advance of the other.

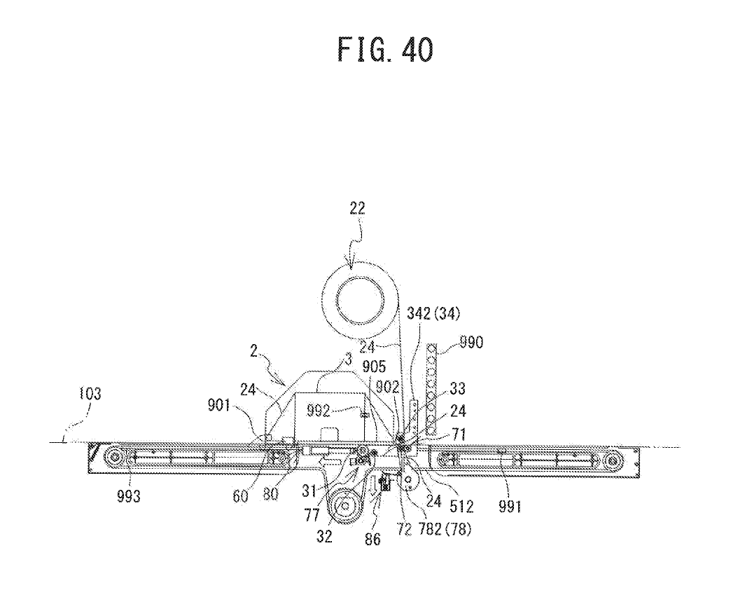

At step S67, the heating portion 86 is lowered from the heating position at a speed of 400 mm/s. Based on a number of revolutions of the third motor 223, when the heating portion 86 has been moved 59.2 mm, the lowering of the heating portion 86 is stopped (refer to FIG. 22). In this manner, as shown in FIG. 40, the heating portion 86 is moved from the heating position to the original position. Meanwhile, the cam 851 is caused to rotate at a rotation speed of 3.75 revolutions per second, and the stopper 81 is thus moved to the downstream side from the regulating position. Based on a number of revolutions of the fourth motor 224, when the cam 851 has been rotated by 305 degrees, the moving of the stopper 81 is stopped. In this manner, as shown in FIG. 40, the stopper 81 is moved from the regulating position to the original position and the rotation of the guide roller 31 is allowed.

The CPU 201 performs the fourth conveyance operation (step S69). The fourth conveyance operation is a control that conveys the base 2 to the downstream side from the rear end bonding position to the end position. At step S69, the conveyance portions 60 are conveyed from the fourth position to the downstream side at a speed of 440 mm/s (refer to FIG. 22). The CPU 201 determines whether the base discharge sensor 993 is ON (step S71). When the base 2 that has been completely packaged is conveyed to the end position, the base discharge sensor 993 detects the base 2 in the end position and is thus ON (yes at step S71). In this case, the CPU 201 stops the fourth conveyance operation (step S73). In this manner, as shown in FIG. 41, the conveyance portions 60 move to the second position and the base 2 is moved from the rear end bonding position to the end position. The completely packaged base 2 and object 3 are conveyed from the base transit portion 805 to the downstream side and are arranged on the receiving surface 13A.

When the base discharge sensor 993 is OFF (no at step S71), the CPU 201 continues the fourth conveyance operation (step S75), and determines whether a specific time period has elapsed from the start of the processing at step S69 (step S77). When the specific time period has not elapsed (no at step S77), the processing is returned to step S71, and the CPU 201 waits for the base discharge sensor 993 to detect the base 2 within the specific time period. When the specific time period has elapsed (yes at step S77), the CPU 201 performs the error control (step S45), and ends the packaging processing.

After performing the processing at step S73, the CPU 201 determines whether the base discharge sensor 993 is OFF (step S79). When the user removes the completely packaged base 2 and object 3 from the conveyance portions 60, the base discharge sensor 993 switches to OFF (yes at step S79). When the base discharge sensor 993 is ON (no at step S79), the processing returns to step S79 and the CPU 201 waits for the base discharge sensor 993 to switch to OFF.

When the base discharge sensor 993 is OFF (yes at step S79), the CPU 201 concurrently returns the conveyance portions 60, raises the movable rollers 30 and returns the cutter 77 (step S81). In the present embodiment, the return of the conveyance portions 60, the raising of the movable rollers 30 and the return of the cutter 77 are started simultaneously. However, as long as execution time periods of each of the operations at least partially overlap with each other, and as long as there is no interference between each of the operations, the return of the conveyance portions 60, the raising of the movable rollers 30 and the return of the cutter 77 may be started in any order.

At step S81, the conveyance portions 60 are moved to the upstream side from the second position at a speed of 220 mm/s. Based on a number of revolutions of the second motor 222, when the conveyance portions 60 have been moved 640 mm, the moving of the conveyance portions 60 is stopped (refer to FIG. 22). The support portions 34 that support the movable rollers 30 are raised from the lowered position at a speed of 80 mm/s. Based on a number of revolutions of the first motor 221, when the support portions 34 have been moved 161.5 mm, the raising of the support portions 34 is stopped (refer to FIG. 22). The cutter 77 is moved from the right end of the movable range to the left at a speed of 400 mm/s. Based on a number of revolutions of the fifth motor 225, when the cutter 77 has been moved 244.5 mm, the moving of the cutter 77 is stopped (refer to FIG. 22).

In this manner, the conveyance portions 60 move to the first position and the base 2 is moved from the end position to the start position. The support portions 34 are moved from the lowered position to the original position, and the guide roller 31 is moved from the lower guide position to the upper guide position. The cutter 77 moves from the right end of the movable range to the original position. In other words, the packaging device 1 is returned to the initialized state. After performing the processing at step S81, the CPU 201 ends the packaging processing. After that, the user attaches the new base 2 to the conveyance portions 60 and places the new object 3 on the base 2. The user presses the start button (not shown in the drawings) and thus once more performs the packaging of the new base 2 and object 3.

When the packaging device 1 is performing the packaging processing, there are cases in which an error state occurs when the packaging processing cannot be performed appropriately. The error state includes, for example, a case in which the film 24 becomes caught up inside the base transit portion 805, or a case in which the base 2 or the object 3 become stuck in the base transit portion 805. In this type of case, when the user presses a forced discharge button that is not shown in the drawings, a forced discharge command is input to the CPU 201. When the forced discharge command is input, the CPU 201 starts the forced discharge processing, based on the programs stored in the ROM 202.

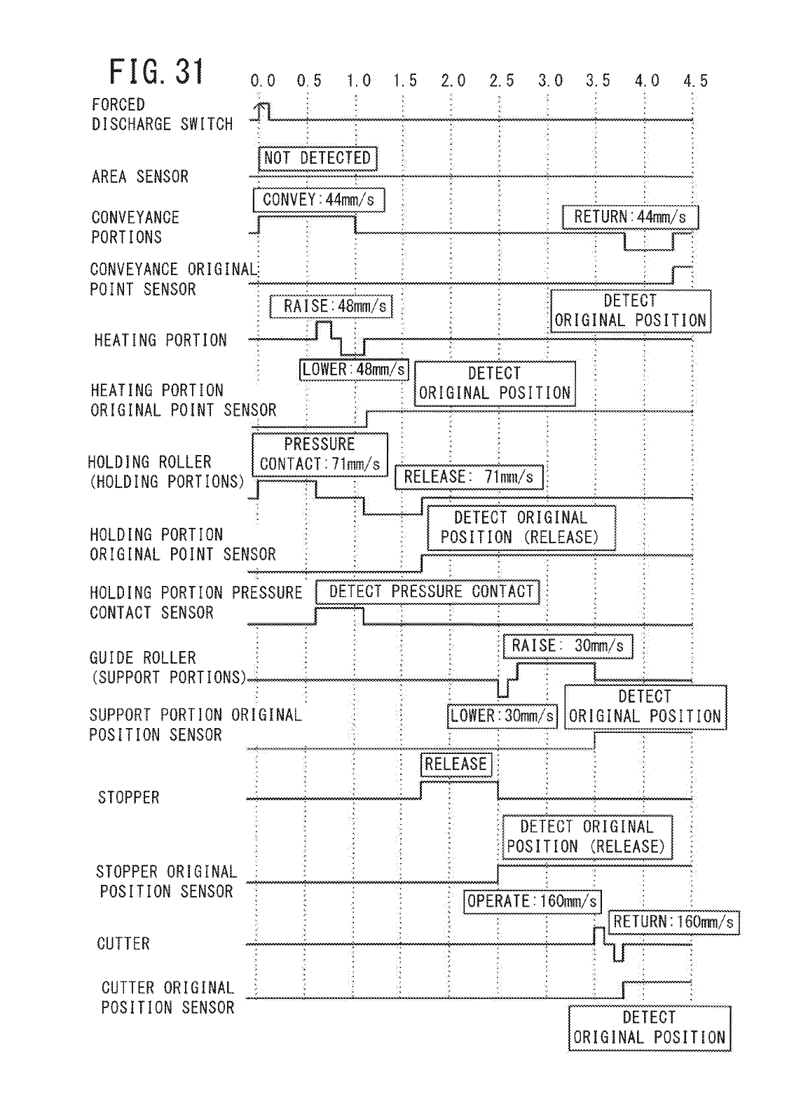

The forced discharge processing will be explained with reference to a flowchart shown in FIG. 30 and a timing chart shown in FIG. 31. The CPU 201 starts the moving of the conveyance portions 60 (step S101). At step S101, the conveyance portions 60 are conveyed from the current position to the downstream side at a speed of 44 mm/s (refer to FIG. 21). When the base discharge sensor 993 is ON, the moving of the conveyance portions 60 is stopped. In this manner, the conveyance portions 60 are moved to the second position. When the base 2 is attached to the conveyance portions 60, the base 2 is moved to the end position.

When the moving of the conveyance portions 60 is started at step S101, the CPU 201 performs the processing in the same manner as that at step S5 to step S15 (step S103 to step S113). In this manner, the holding portions 78, the heating portion 86, the stopper 81, the support portions 34 and the cutter 77 are each moved to their respective original positions. The guide roller 31 is moved to the upper guide position. Finally, the CPU 201 returns the conveyance portions 60 to the original position (that is, the first position) (step S115). At step S115, the conveyance portions 60 are moved to the upstream side from the second position at a speed of 44 mm/s (refer to FIG. 21). When the conveyance original point sensor 980 is ON, the moving of the conveyance portions 60 is stopped. In this manner, the conveyance portions 60 are moved to the first position. When the base 2 is attached to the conveyance portions 60, the base 2 is moved to the start position. The user can recover the base 2 and the object 3 from the packaging device 1 that is in the error state.

(13) Effects of Packaging Device 1

Effects of the packaging device 1 according to the above-described embodiment are exemplified below. In the packaging device 1, the film 24 that is guided from the guide roller 31 in the upper guide position to the heating portion 86 intersects the conveyance path 103, and, in this state, the conveyance portions 60 are moved from the first position to the third position. The base 2 is thus conveyed from the start position to the front end bonding position (step S27). The film 24 is bonded to the first base end portion 928 by the heating portion 86 (step S33). The conveyance portions 60 are moved from the third position to the fifth position, and the base 2 is thus conveyed from the front end bonding position to the avoidance position (step S39). The guide roller 31 is moved from the upper guide position to the lower guide position (step S55), and the object 3 placed on the base 2 is covered by the film 24. The film 24 that extends from the guide roller 31 toward the object 3 intersects the conveyance path 103, and, in this state, the conveyance portions 60 are moved from the fifth position to the fourth position. The base 2 is thus conveyed from the avoidance position to the rear end bonding position (step S57). The film 24 is bonded to the second base end portion 929 by the heating portion 86 (step S63). The conveyance portions 60 are moved from the fourth position to the second position and the base 2 is conveyed from the rear end bonding position to the end position (step S69).

In this manner, in the course of moving the base 2 along the conveyance path 103, by moving the guide roller 31 along the movement path 104, the base 2 and the object 3 are wrapped by the film 24. The guide roller 31 does not move around the whole area surrounding the base 2 and the object 3, and thus the movement path 104 of the guide roller 31 is short. As a result, the packaging device 1 can package the large object 3 with the film 24 without increasing the size of the packaging device 1.

In the packaging processing shown in FIG. 26 to FIG. 29, the movement speed of the conveyance portions 60 in the first conveyance operation (step S27) is slower than in the second conveyance operation (step S39), the third conveyance operation (step S57) and the fourth conveyance operation (step S69) (refer to FIG. 22). In other words, in the course of the packaging operation by which the base 2 and the object 3 are packaged by the film 24, of the speeds at which the base 2 is conveyed, the speed when the base 2 that is attached to the conveyance portions 60 is first conveyed is the slowest. It is therefore possible to inhibit displacement of the base 2 from occurring before the film 24 is bonded, and to convey the base 2 in a safe manner to the position at which the bonding of the film 24 is performed.

In the initialization processing shown in FIG. 24 and FIG. 25 and in the forced discharge processing shown in FIG. 30 and FIG. 31, the movement speeds of each of the processes (specifically, each of the movement speeds of the conveyance portions 60, the holding portions 78, the heating portion 86, the stopper 81, the movable rollers 30 and the cutter 77) are slower than in the packaging processing shown in FIG. 26 to FIG. 29 (refer to FIG. 21). As a result, in the initialization processing, it is possible to initialize the packaging device 1 in a safe manner. In the forced discharge processing, the user can safely recover the base 2 and the object 3 from the packaging device 1 that is in the error state.

The movement speed of the conveyance portions 60 in each of the initialization processing and the forced discharge processing is slower than the movement speed of the conveyance portions 60 in the packaging processing (refer to FIG. 21, FIG. 22). The movement speed of the conveyance portions 60 in the forced discharge processing is slower than the movement speed of the conveyance portions 60 in the initialization processing (refer to FIG. 21). As there is a possibility that a problem of safety may arise with the packaging device 1 in the error state, it is possible to inhibit the risk of injury to the user when recovering the base 2 and the object 3 by reducing the conveyance speed of the base 2 during the forced discharge processing to the slowest speed.

In the initialization processing and the packaging processing, the error control is performed (step S1, step S3, step S29, step S41 to step S45, step S51, step S71, step S75 and step S77) based on detection results of a plurality of sensors (the area sensor 990, the base center sensor 992 and the base discharge sensor 993, for example). In this way, it is possible to perform an emergency stop of the packaging operation when an abnormality arises in the packaging device 1, and safety of the packaging operation can be improved.

In the packaging processing, the plurality of operations are performed overlapping with each other (step S27, step S39, step S59, step S61, step S67 and step S81). In this way, compared to a case in which each of the operations is performed in sequence, it is possible to reduce the time to perform the packaging operation. For example, at the same time as conveying the base 2, the heating portion 86 is moved from the original position to the stand-by position (step S27). The heating portion 86 is moved from the stand-by position to the heating position and the film 24 is bonded to the first base end portion 928 by the heating portion 86 (step S31 and step S33). In this manner, by moving the heating portion 86 to the stand-by position while the base 2 is being moved from the start position to the front end bonding position, such that the distance to the heating position is shorter, the time of the operation to move the heating portion 86 to the heating position after the base 2 has been conveyed to the front end bonding position is shorter.

Concurrently with starting the conveyance of the base 2 after the film 24 has been bonded to the first base end portion 928, the holding of the film 24 that is guided toward the heating portion 86 is released (step S39). As a result, it is possible to reduce the time to perform the packaging operation in comparison to starting the conveyance of the base 2 after releasing the holding of the film 24 that is guided toward the heating portion 86.

Concurrently with the stopper 81 regulating the rotation of the guide roller 31, the moving of the cutter 77 is started in order to cut the film 24 (step S59). As a result, it is possible to reduce the time to perform the packaging operation in comparison to starting the moving of the cutter 77 after the rotation of the guide roller 31 has been regulated.

Concurrently with the cut away film 24 being held, the moving of the heating portion 86 to the bonding position is started (step S61). As a result, it is possible to reduce the time to perform the packaging operation in comparison to starting the moving of the heating portion 86 after the cut away film 24 has been held.

Concurrently with moving the heating portion 86 to the bonding position, the moving of the stopper 81 is started in order to regulate the rotation of the guide roller 31 (step S67). As a result, it is possible to reduce the time to perform the packaging operation in comparison to starting the moving of the stopper 81 after the heating portion 86 has been moved.

In the packaging processing, the conveyance amount of at least one of the second conveyance operation and the third conveyance operation is changed and the bonding time of at least one of the front end bonding (step S33) and the rear end bonding (step S63) is changed depending on the tension of the film 24 set by the torque adjustment mechanism 40. In this way, irrespective of the tension of the film 24, the base 2 and the object 3 can be accurately packaged by the film 24.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A packaging device that is configured to package, with a film, an object and a base on which the object is placed, the packaging device comprising:
a conveyance mechanism configured to convey the base along a specific conveyance path;
a heater configured to heat the film and bond the film to the base that is conveyed by the conveyance mechanism, the heater being configured to move between a proximate position, a separate position and a stand-by position, the proximate position being a position at which the heater is in close proximity to the conveyance path, the separate position being a position at which the heater is separated from the conveyance path, and the stand-by position being a position that is positioned between the separate position and the proximate position;
a guide portion configured to guide the film toward the heater and configured to move along a movement path, the movement path extending in a direction intersecting the conveyance path; and
a processor configured to:
cause the conveyance mechanism to convey the base from a start position to a first bonding position in a state in which the guide portion is in a first guiding position and in which the film that is guided from the guide portion to the heater intersects the conveyance path, the first guiding position being a position on the movement path at which the guide portion and the heater are disposed on different sides of the conveyance path, the start position being a position on the conveyance path at which the base is disposed before being packaged by the film, the first bonding position being another position on the conveyance path at which the heater can bond the film to a first base end, the first base end being an end of the base in a first direction, the first direction being a direction from the start position toward an end position, the end position being yet another position on the conveyance path at which the base is disposed after being packaged by the film, and the first bonding position being positioned between the start position and the end position;
move the heater from the separate position to the stand-by position when the base is conveyed from the start position to the first bonding position;
move the heater from the stand-by position to the proximate position when the base is conveyed to the first bonding position, and cause the heater to bond the film to the first base end;
cause the conveyance mechanism to convey the base from the first bonding position to an avoidance position after the film is bonded to the first base end, the avoidance position being yet another position on the conveyance path at which the whole of the base is positioned further in the first direction than the movement path, the avoidance position being positioned between the start position and the end position and being positioned further in the first direction than the first bonding position;
cover, with the film, the object that is placed on the base, by moving the guide portion from the first guiding position to a second guiding position after the base is conveyed to the avoidance position, the second guiding position being yet another position on the movement path at which the guide portion and the heater are disposed on the same side of the conveyance path;
cause the conveyance mechanism to convey the base from the avoidance position to a second bonding position in a state in which the film extending from the guide portion toward the object intersects the conveyance path after the guide portion is moved to the second guiding position, the second bonding position being yet another position on the conveyance path at which the heater can bond the film to a second base end, the second base end being an end of the base in a second direction, the second direction being a direction from the start position toward the end position, and the second bonding position being positioned between the first bonding position and the avoidance position;
move the heater from the separate position to the proximate position after the base is conveyed to the second bonding position, and cause the heater to bond the film to the second base end; and
cause the conveyance mechanism to convey the base from the second bonding position to the end position after the film is bonded to the second base end.

2. The packaging device according to claim 1, further comprising:
a holding portion configured to hold the film that is guided from the guide portion toward the heater;
wherein the processor is further configured to:
cause the holding portion to release the holding of the film when the base is conveyed from the first bonding position to the avoidance position.

3. The packaging device according to claim 2, wherein
the guide portion is a column-shaped roller that is configured to guide the film by rotating,
the packaging device further comprises:
a stopper configured to move between a regulating position and an allowing position, the regulating position being a position at which the stopper is in close proximity to the guide portion that is in the second guiding position and regulates rotation of the guide portion, and the allowing position being a position of the stopper at which the stopper is separated from the guide portion that is in the second guiding position and allows the rotation of the guide portion; and
a cutter configured to cut away the film that is bonded to the base from the guide portion, by moving in a direction that is orthogonal to the conveyance path and to the movement path; and
the processor is further configured to:
move the stopper from the allowing position to the regulating position after the base is conveyed by the conveyance mechanism to the second bonding position and before the film is bonded to the second base end; and
cause the cutter to start moving before the stopper has moved from the allowing position to the regulating position, and cause the cutter to cut away the film after the stopper has moved to the regulating position.

4. The packaging device according to claim 3, wherein
the processor is further configured to:
cause the holding portion to hold the film that is cut away, after the film is cut away by the cutter; and
the heater is caused to move from the separate position to the proximate position when the holding portion holds the cut away film.

5. The packaging device according to claim 3, wherein
the processor is further configured to:
move the heater from the proximate position to the separate position after the film is bonded to the second base end; and
the stopper is moved from the regulating position to the allowing position when the heater moves from the proximate position to the separate position.
